(19) United States
(12) Patent Application Publication
(10) Pub. No.: US 2026/0152262 A1
(43) Pub. Date: Jun. 4, 2026

(54) WATER SPORT APPARATUS, CONTROL SYSTEMS AND METHODS

(71) Applicant: Fliteboard Pty Ltd, Byron Bay, NSW (AU)

(72) Inventors: Emma Reynolds, Suffolk Park, NSW (AU); Chris Reynolds, Suffolk Park, NSW (AU)

(73) Assignee: Fliteboard Pty Ltd, Byron Bay, NSW (AU)

(21) Appl. No.: 18/706,549

(22) PCT Filed: Nov. 2, 2022
(86) PCT No.: PCT/AU2022/051315

§ 371 Date: May 1, 2024

(30) Foreign Application Priority Data
Nov. 3, 2021 (AU) 2021903520

(51) Int. Cl. B63B 34/10; B63B 34/40; B63B 79/10; B63B 79/40; B63H 21/17; B63H 21/21

(52) U.S. Cl. CPC B63B 34/10; B63B 34/40; B63B 79/10; B63B 79/40; B63H 21/17; B63H 21/21; B63B 2213/02; B63H 2021/216

(57) ABSTRACT

The water sport apparatus has: a propulsion system that is configured to propel the water sport apparatus, the propulsion system having: an impeller; and a drive system that is configured to drive the impeller to propel the water sport apparatus. The water sport apparatus has a controller for controlling the propulsion system, the controller comprising a sensor system; wherein the controller is configured to: determine a speed estimate that is indicative of a speed of the water sport apparatus using sensor data determined using the sensor system; compare the speed estimate to a speed threshold; and activate the drive system to drive the impeller in response to the speed estimate being equal to or greater than the speed threshold.

### CROSS-REFERENCE TO RELATED APPLICATIONS

This application is the U.S. national stage application of International Application No. PCT/AU 2022/051315, filed Nov. 2, 2022, which international application was published on May 11, 2023, as International Publication WO 2023/077187 in the English language. The International Application claims priority of Australian Patent Application No. 2021903520, filed Nov. 3, 2021. The international application and Australian application are both incorporated herein by reference, in entirety.

### TECHNICAL FIELD

The present disclosure relates to apparatuses for water sports, such as surfboards, kiteboards, wakeboards, foil boards, and the like. In particular, the present disclosure relates to controlling powered boards for water sports.

### BACKGROUND

A board used in water sports typically requires a user or an external system to propel the board to a sufficient speed to perform the relevant water sport. For example, a surfer paddles whilst lying on their surfboard to increase their speed in anticipation of catching a wave travelling at a similar speed. Boards with a propulsion system (which may be referred to as powered boards) can be used to provide an initial acceleration, velocity and/or speed so that there is less reliance on the user or the relevant external system (e.g. a boat) to propel the board, and less reliance on external conditions such as suitable waves (and catching them at an appropriate angle).

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In some embodiments, there is provided a water sport apparatus. The water sport apparatus may comprise: a propulsion system that is configured to propel the water sport apparatus, the propulsion system comprising: an impeller; and a drive system that is configured to drive the impeller to propel the water sport apparatus; a controller for controlling the propulsion system, the controller comprising a sensor system. The controller may be configured to: determine a speed estimate that is indicative of a speed of the water sport apparatus using sensor data determined using the sensor system; compare the speed estimate to a speed threshold; and activate the drive system to drive the impeller in response to the speed estimate being equal to or greater than the speed threshold.

In some embodiments, the controller is configured to: receive a propulsion system activation input; and activate the drive system to drive the impeller in response to: receiving the propulsion system activation input; and the speed estimate being equal to or greater than the speed threshold.

In some embodiments, there is provided a water sport apparatus. The water sport apparatus may comprise: a propulsion system that is configured to propel the water sport apparatus, the propulsion system comprising: an impeller; and a drive system that is configured to drive the impeller to propel the water sport apparatus; and a controller for controlling the propulsion system. The controller may be configured to: receive a propulsion system activation delay input that is indicative of a time delay duration associated with activation of the propulsion system; and activate the drive system to drive the impeller after a time period corresponding to the time delay duration elapses.

In some embodiments, the controller is configured to: receive a propulsion system activation input; and activate the drive system to drive the impeller, in response to receiving the propulsion system activation input, after the time period corresponding to the time delay duration elapses.

In some embodiments, there is provided a water sport apparatus. The water sport apparatus may comprise: a propulsion system that is configured to propel the water sport apparatus, the propulsion system comprising: an impeller; and a drive system that is configured to drive the impeller to propel the water sport apparatus; and a controller for controlling the propulsion system. The controller may be configured to: receive a thrust time window input that is indicative of a duration of a thrust time window; activate the drive system to drive the impeller for an activation duration that is equal to the duration of the thrust time window; and deactivate the drive system after the activation duration elapses.

In some embodiments, the controller is configured to: receive a propulsion system activation input; and activate the drive system to drive the impeller, in response to receiving the propulsion system activation input, for the activation duration.

In some embodiments, the controller comprises a sensor system; and the controller is configured to process sensor data determined using the sensor system.

In some embodiments, the drive system comprises: a motor comprising: a stator; a rotor; and a shaft connected to the rotor; wherein the shaft is configured to connect to the impeller.

In some embodiments, the sensor system comprises one or more of: a Global Navigation Satellite System (GNSS) module that is configured to receive GNSS data; a gyroscope; a magnetometer; and an accelerometer.

In some embodiments, the controller further comprises a user interface that is configured to enable a user to provide an input to the controller.

In some embodiments, the user interface comprises: a display; and one or more buttons.

In some embodiments, the propulsion system activation input is received via the user interface.

In some embodiments, the controller is configured to activate the drive system in accordance with an activation configuration.

In some embodiments, the activation configuration comprises one or more activation configuration parameters, the activation configuration parameters comprising: a thrust parameter that is associated with a target thrust of the propulsion system; an output current parameter that is associated with a target current to be drawn by a component of the drive system; an output revolutions-per-minute (RPM) parameter that is associated with a target RPM of the component of the drive system; an acceleration parameter that is associated with an acceleration time window over which the drive system is activated, such that the propulsion system delivers a target thrust at an end of the acceleration time window; a thrust duration parameter that is associated with a thrust duration time window over which the drive system is to be activated; a maximum speed parameter that is associated with a maximum speed at which the water sport apparatus is to be propelled; and a cavitation time parameter that is associated with a cavitation time duration.

In some embodiments, a value of one or more of the thrust parameter, the output current parameter, the output RPM parameter, the acceleration parameter, the thrust duration parameter, the maximum speed parameter and the cavitation time parameter is pre-set.

In some embodiments, the controller is configured to receive a value of one or more of the thrust parameter, the output current parameter, the output RPM parameter, the acceleration parameter, the thrust duration parameter, the maximum speed parameter and the cavitation time parameter via the user interface.

In some embodiments, determining the speed estimate comprises: determining a first position estimate that is indicative of a first position of the water sport apparatus at a first time; determining a second position estimate that is indicative of a second position of the water sport apparatus at a second time; and determining the speed estimate based at least in part on a difference between the first position estimate and the second position estimate, and a difference between the first time and the second time.

In some embodiments, the controller is configured to: determine the first position estimate using first GNSS data that is associated with the first time; and determine the second position estimate based at least in part on second GNSS data that is associated with the second time.

In some embodiments, the controller is configured to determine: the value of one or more operational parameter(s) that is indicative of a thrust of the propulsion system at a first time; and the value of one or more operational parameter(s) that is indicative of the thrust of the propulsion system at a second time that is after the first time.

In some embodiments, the one or more operational parameter(s) comprise a current parameter.

In some embodiments, the controller is further configured to: compare the value of the current parameter at a first time to a current threshold; compare the value of the current parameter at a second time to the current threshold; and deactivate the drive system when: the value of the current parameter at the first time is above the current threshold; and the value of the current parameter at the second time is equal to or below the current threshold.

In some embodiments, the one or more operational parameter(s) comprise a revolutions-per-minute (RPM) parameter.

In some embodiments, the controller is further configured to: compare the value of the RPM parameter at a first time to a RPM threshold; compare the value of the RPM parameter at a second time to the RPM threshold; and deactivate the drive system when: the value of the RPM parameter at the first time is below the RPM threshold; and the value of the RPM parameter at the second time is equal to or above the RPM threshold.

In some embodiments, the speed estimate is a first speed estimate that is associated with a first speed estimate time; and the controller is further configured to: determine a second speed estimate that is indicative of a second speed of the water sport apparatus at second speed estimate time, using the sensor data; and activate the drive system to drive the impeller in response to: the first speed estimate being less than the speed threshold; and the second speed estimate being greater than or equal to the speed threshold; wherein the first speed estimate time is before the second estimate time.

In some embodiments, the first speed estimate time and the second speed estimate time are within an allowable time window.

In some embodiments, the propulsion system activation delay input is received using the user interface.

In some embodiments, the thrust time window input is received using the user interface.

In some embodiments, the water sport apparatus further comprises: a jet system body comprising: a first inlet conduit comprising: a first inlet end defining a first inlet opening; a first outlet end defining a first outlet opening; a first lumen extending from the first inlet opening to the first outlet opening; a second inlet conduit comprising: a second inlet end defining a second inlet opening; a second outlet end defining a second outlet opening; a second lumen extending from the second inlet opening to the second outlet opening; a manifold in fluid communication with the first outlet opening and the second outlet opening; and an outlet in fluid communication with the manifold and configured to receive an impeller for drawing fluid through the first and second inlet conduits, through the manifold and into the outlet; wherein the first inlet conduit and the second inlet conduit extend from the manifold such that the first inlet end and the second inlet end are spaced apart.

In some embodiments, the water sport apparatus further comprises: a mast mount; a mast configured to be connected to the mast mount; and a hydrofoil configured to be connected to the mast.

In some embodiments, the first inlet end and the second inlet end of the jet system body are configured to be disposed on opposite sides of the mast mount.

In some embodiments, there is provided a computer-implemented method for controlling a propulsion system of a water sport apparatus, the propulsion system comprising a drive system and an impeller. The computer-implemented method may comprise: receiving a propulsion system activation input; determining a speed estimate that is indicative of a speed of the water sport apparatus using sensor data; comparing the speed estimate to a speed threshold; and activating the drive system to drive the impeller, in response to: receiving the propulsion system activation input; and the speed estimate being equal to or greater than the speed threshold.

In some embodiments, there is provided a computer-implemented method for controlling a propulsion system of a water sport apparatus, the propulsion system comprising a drive system and an impeller. The computer implemented method may comprise: receiving a propulsion system activation delay input that is indicative of a time delay duration associated with activation of the propulsion system; receiving a propulsion system activation input; and activating the drive system to drive the impeller, in response to receiving the propulsion system activation input, after the time period corresponding to the time delay duration elapses.

In some embodiments, there is provided a computer-implemented method for controlling a propulsion system of a water sport apparatus, the propulsion system comprising a drive system and an impeller. The computer-implemented method may comprise: receiving a thrust time window input that is indicative of a duration of a thrust time window; receiving a propulsion system activation input; activating the drive system to drive the impeller, in response to receiving the propulsion system activation input, for the activation duration; and deactivating the drive system after the activation duration elapses.

### BRIEF DESCRIPTION OF DRAWINGS

Embodiments are described in further detail below, by way of example, with reference to the accompanying drawings, in which:

FIG. 1 is an exploded view of a hydrofoil board;

FIG. 2 is an underside view of a water sport apparatus comprising a jet system, according to some embodiments. FIG. 2 also comprises an inset which shows a cross section view of a nozzle of the jet system;

FIG. 3 is a schematic top view of the water sport apparatus of FIG. 2, according to some embodiments;

FIG. 4A is an exploded view of the jet system of the water sport apparatus of FIG. 2, as seen from above, according to some embodiments;

FIG. 4B is a perspective view of the jet system of FIG. 4A, as assembled and as seen from underneath, according to some embodiments;

FIG. 5A is a perspective view of an impeller of the jet system of the water sport apparatus of FIG. 2, as received in the nozzle, according to some embodiments;

FIG. 5B is an exploded view of FIG. 5A, viewed from a reverse angle, according to some embodiments;

FIG. 6A is a perspective view of a cartridge of the jet system of the water sport apparatus of FIG. 2, according to some embodiments;

FIG. 6B is a section view of FIG. 6A, as taken along the line 6B-6B, according to some embodiments;

FIG. 6C is an exploded view of FIG. 6A, according to some embodiments;

FIG. 7 is a section view as shown in FIG. 6B, as viewed from above, according to some embodiments;

FIG. 8 is a perspective view of an embodiment of the jet system comprising a cartridge housing for receiving the cartridge of FIGS. 6A-6C, according to some embodiments;

FIG. 9 is a block diagram of a powered water sport apparatus system, according to some embodiments;

FIG. 10 is a process flow diagram of a computer-implemented method of controlling a propulsion system of a water sport apparatus, according to some embodiments;

FIG. 11 is a process flow diagram of another computer-implemented method of controlling a propulsion system of a water sport apparatus, according to some embodiments; and

FIG. 12 is a process flow diagram of yet another computer-implemented method of controlling a propulsion system of a water sport apparatus, according to some embodiments.

### DETAILED DESCRIPTION

The present disclosure relates to apparatuses for water sports, such as surfboards, kiteboards, wakeboards, foil boards, and the like. In particular, embodiments relate to methods of controlling powered boards for water sports. Reference is drawn to Australian Patent Application No. 2021903519, entitled “Jet systems for a water sport apparatus”, filed on 3 Nov. 2021, the entire content of which is fully incorporated by reference herein.

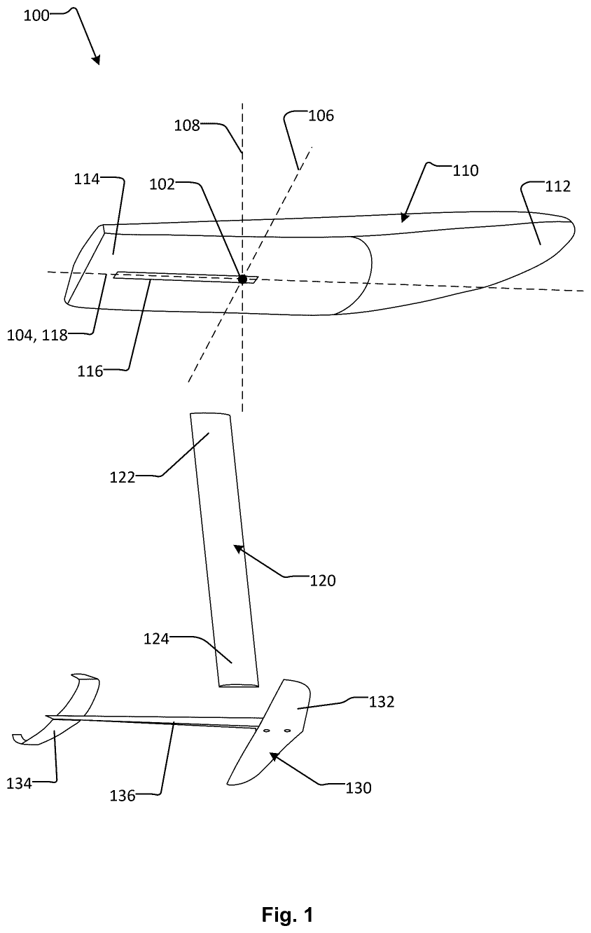

FIG. 1 shows an exploded view of a water sport apparatus 100 (sometimes called a foil board). The water sport apparatus 100 comprises a board 110. The board 110 has a front end 112. The board 110 has a rear end 114. The board 110 may be substantially elongate, extending from the front end 112 to the rear end 114. The front end 112 of the board 110 may be raised relative to the rear end 114 so that in use, water is guided under the board 110 towards the rear end 114.

The board 110 comprises a core and an outer shell. The shell comprises a top surface (or topside) and a bottom surface (or underside). The board 110 is suitable for one or more water sports. The board 110 may be a surfboard, kiteboard, wakeboard, or any similar type of board.

The water sport apparatus 100 has a centre of mass 102. The water sport apparatus 100 is configured to roll (tilt side-to-side) about a roll axis 104 which passes through the centre of mass 102. The roll axis 104 may be referred to as a longitudinal axis of the board 110. The water sport apparatus 100 is configured to pitch (tilt front-rear) about a pitch axis 106 which passes through the centre of mass 102. The water sport apparatus 100 is configured to yaw (turn left or right) about a yaw axis 108 which passes through the centre of mass 102.

In some embodiments, the water sport apparatus 100 comprises a mast 120. The mast 120 is connected to the board 110 at a mast mount 116. The mast mount 116 is typically positioned towards the rear end 114 of the board 110. That is, the mast mount 116 is closer to the rear end 114 of the board 110 than to the front end 112. For stability, the mast mount 116 is typically aligned with the roll axis 104 of the board 110. The roll axis 104 is preferably collinear with a longitudinal centreline 118 of the board 110. The board 110 is symmetrical about the longitudinal centreline 118, which extends between the front end 112 and rear end 114.

The mast 120 comprises a first end 122 which attaches to the mast mount 116. The mast 120 comprises an opposed second end 124. A foil (hydrofoil) 130 is configured to connect to the second end 124. The mast mount 116 comprises at least one rail or track along which the first end 122 of the mast 120 can be received and slid into a desired position. The mast mount 116 may also be referred to as a “track box” or “Tuttle box”.

The position of the mast 120 may be selectively varied depending on the wind and water conditions as well as the rider's skill, weight, or surfing style. For example, moving the mast 120 towards the front end 112 of the board 110 may make the assembled water sport apparatus 100 easier to control but be less responsive to the foil 130. Conversely, moving the mast 120 towards the rear end 114 of the board 110 may make the assembled water sport apparatus 100 more responsive to the foil 130 but harder to control. Moving the mast 120 forward may enable the foil 130 to generate more lift compared to moving the mast 120 (and foil 130) rearward.

The foil 130 comprises a front wing 132. The foil 130 comprises a rear stabiliser 134. The rear stabiliser 134 may take the form of a wing or winglet. The foil 130 comprises an elongate fuselage 136. The front wing 132 and the rear stabiliser 134 are configured to be connected to opposite ends of the fuselage 136.

The location of the centre of mass 102 (and consequently, the ability to roll, pitch, or yaw the water sport apparatus 100) is affected by the distribution of weight across the water sport apparatus 100. The board 110, the mast mount 116, the mast 120, and the foil 130 each have respective masses such that when these components are attached to each other, they cumulatively shift the position of the centre of mass of the board 110 to the centre of mass 102 of the water sport apparatus 100.

The water sport apparatus 100 shown in FIG. 1 is unpowered. In use, the water sport apparatus 100 relies on the movement of the water sport apparatus 100 and/or water interacting with the foil 130 to lift the water sport apparatus 100. The wing 132 generates a lift force in response to relative movement between the water sport apparatus 100 and water around the wing 132. Preferably, the centre of mass 102 of the water sport apparatus 100 is positioned over the wing 132. This means that the lift force vector passes through the centre of mass 102 or passes near the centre of mass 102, so that the water sport apparatus 100 is lifted in a balanced way (i.e. the lift force does not cause the water sport apparatus 100 to roll, pitch, or yaw).

The wing 132 defines an aerofoil shape to generate lift with movement of water around the wing 132. Water flow around the foil 130 may be caused by the user propelling the water sport apparatus 100. For example, the user may propel the water sport apparatus 100 onto a wave, after which, movement of the water sport apparatus 100 by the wave may cause the water flow around the wing 132. Alternatively, the user (rider) riding the water sport apparatus 100 may be connected to a kite which catches the wind, thereby towing the user and the water sport apparatus 100 through the water and causing water to flow around the foil 130. A similar tow can be achieved using a motorboat in wakeboarding.

The rear stabiliser 134 stabilises the foil 130 by providing a balancing force that counteracts the lift generated by the wing 132. When the lift force is larger than the weight of the water sport apparatus 100 and its rider, the foil 130 raises the board 110 out of the water, thereby reducing drag. This allows the user (rider) to ride smaller, less energised waves compared to a board without a foil. Alternatively, where the board 110 is a kiteboard, the user can use a kite of a particular size to take advantage of wind speeds that are lower than those ordinarily useable with that particular kite if the user were to be using a board without a foil.

When waves are weak, or when wind speeds are low, the rider of an unpowered foil board can find it difficult to propel the unpowered foil board to a sufficient speed to provide sufficient water movement past the foil 130 to generate lift. To address this, foil boards can include a propulsion system which propels the board 110 through the water to generate the initial lift using the foil 130. The propulsion system may comprise a motor connected to an impeller to generate thrust (a jet of water) which propels or pushes the board 110 through the water.

### Water Sport Apparatus 200

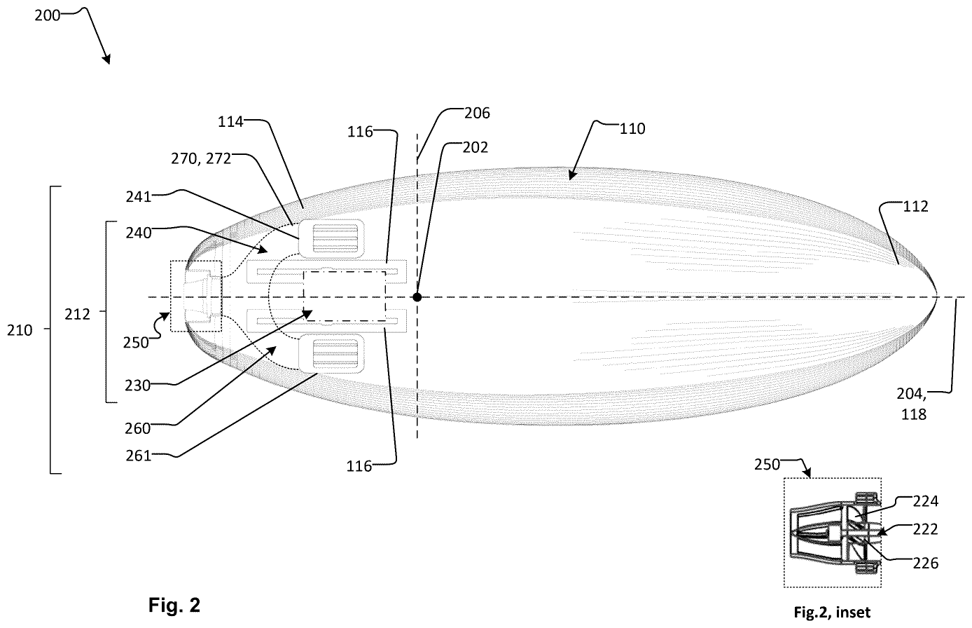

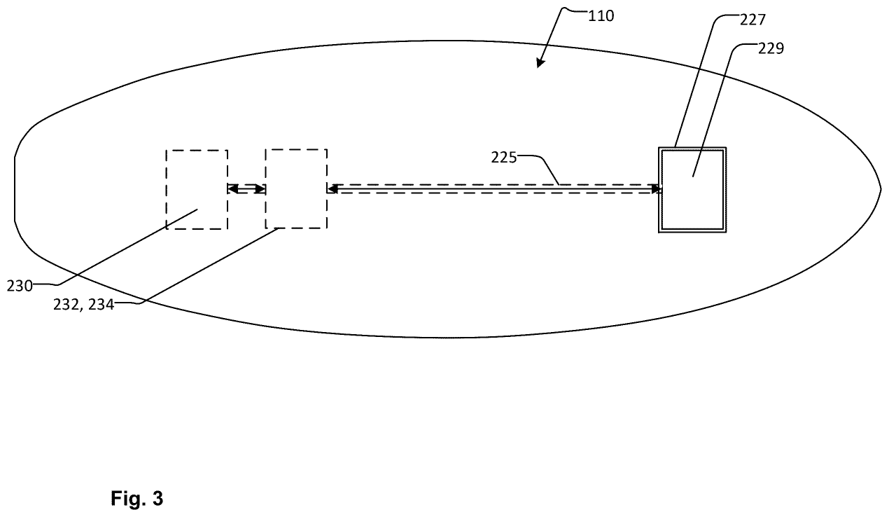

FIG. 2 shows an underside view of a water sport apparatus 200, according to some embodiments. FIG. 3 shows a top view of the water sport apparatus 200. The water sport apparatus 200 comprises a jet system 210. The jet system 210 may also be applied to surfboards, kiteboards, wakeboards, and the like where a hydrofoil is not present. In some embodiments, the water sport apparatus 200 is a jet-powered board 200. In some embodiments, the water sport apparatus 200 is a jet-powered hydrofoil board 200. The jet system 210 may be referred to as a twin-intake jet system.

The jet system 210 comprises a propulsion system 220. The propulsion system 220 is configured to propel the water sport apparatus 200. In particular, the propulsion system 220 is configured to propel the water sport apparatus 200 through, across and/or on a fluid such as water.

The propulsion system 220 comprises a drive system 230. The drive system comprises a motor 236. The motor 236 comprises a stator. The motor 236 comprises a rotor. The rotor is configured to rotate with respect to the stator. In particular, the motor 236 is configured to be controlled such that the rotor controllably rotates with respect to the stator. The motor 236 comprises a shaft 340. The shaft 340 may be referred to as a drive shaft. The shaft 340 is connected to the rotor. The shaft 340 may be directly connected to the rotor. Alternatively, the shaft 340 may be indirectly connected to the rotor (e.g. through a gear box or one or more other components). Thus, rotation of the rotor causes corresponding rotation of the shaft 340.

The propulsion system 220 comprises an impeller 222. The impeller 222 is driven by the drive system 230. In particular, the impeller 222 is driven by the drive system 230 to propel the water sport apparatus 200. The impeller 222 is configured to be connected to the shaft 340. Thus, rotation of the shaft causes corresponding rotation of the impeller 222. The impeller 222 has a plurality of blades 224 which move fluid when the impeller 222 is rotated. The blades 224 may be attached to a hub 226. The shaft 340 may be directly connected to the impeller 222. Alternatively, the shaft 340 may be indirectly connected to the impeller 222 (e.g. through a gear box or one or more other components).

Similar to the water sport apparatus 100, the water sport apparatus 200 has a centre of mass 202. The water sport apparatus 200 is configured to roll about a roll axis 204. The roll axis 204 may pass through the centre of mass 202. The water sport apparatus 200 is configured to pitch about a pitch axis 206. The pitch axis 206 may pass through the centre of mass 202. The water sport apparatus 200 is configured to yaw about a yaw axis 208. The yaw axis 208 may pass through the centre of mass 202. As FIG. 2 is an underside view of the board 110, the yaw axis 208 runs into the page and is not shown.

In some embodiments, the jet system 210 comprises a jet system body 212. The jet system body 212 comprises a first inlet conduit 240. The first inlet conduit 240 may be referred to as a first intake conduit. The first inlet conduit 240 is configured to be fluidly connected to, or in fluid communication with, an outlet 250 of the jet system body 212. The first inlet conduit 240 is in fluid communication with a first inlet aperture 241 defined by the underside of the board 110.

The jet system body 212 further comprises a second inlet conduit 260. The second inlet conduit 260 may be referred to as a second intake conduit. The second inlet conduit 260 is configured to be fluidly connected to, or in fluid communication with, the outlet 250. The second inlet conduit 260 is in fluid communication with a second inlet aperture 261 defined in the underside of the board 110.

In some embodiments, the core of the board 110 defines a cavity 270. The cavity 270 is wholly contained within the board 110 and is not accessible from an outer surface of the board 110. In some embodiments, the board 110 defines a recessed portion 272. The recessed portion 272 may be defined by the outer shell. The recessed portion 272 may extend from the underside of the board 110 to the core of the board 110. In some embodiments, the recessed portion 272 is connected to the cavity 270. As shown in FIG. 2, the cavity 270 and the recessed portion 272 may be connected to form a tunnel or passage in which at least one of the inlet conduits 240, 260 may be retrieved, for example.

The cavity 270 and/or the recessed portion 272 may be defined in the rear end 114 of the board 110. The cavity 270 and/or the recessed portion 272 may be configured to at least partially receive the jet system 210. In particular, the cavity 270 and/or the recessed portion 272 may be configured to at least partially receive the first inlet conduit 240 and the second inlet conduit 260. In FIG. 2, the first and second inlet conduits 240, 260 are shown in dotted lines as an example of their positioning when the conduits 240, 260 are received in the cavity 270 and/or the recessed portion 272.

A shroud or cover may be provided to cover the recessed portion 272. The shroud may be configured to be flush with the underside of the board 110 when the shroud is in place covering the recessed portion 272. The underside of the board 110 at the rear end 114 may be substantially flat when the shroud is in place over the cavity 270 and/or the recessed portion 272. The shroud may protect the first and second inlet conduits 240, 260 from debris. The shroud may have a seal to reduce or prevent water ingress into the cavity 270 and/or the recessed portion 272. All seals on the jet system 210 may have a minimum dust and water resistance IP rating of 68, unless noted otherwise.

The water sport apparatus 200 may be controlled by a control system. The water sport apparatus 200 comprises a controller 234. The controller 234 controls the propulsion system 220. In particular, the controller 234 controls the motor 236 to spin the impeller 222, as is described herein.

In some embodiments, the impeller 222 is disposed at the outlet 250. The spinning impeller 222 draws fluid (air or water) from the underside of the board 110 through the inlet apertures 241 and 261. The fluid flows through the respective inlet conduits 240, 260 into the outlet 250 where it meets the impeller 222. The fluid passing through the impeller 222 is accelerated and expelled through the outlet 250 as a jet, providing thrust.

To improve ride predictability and safety of the water sport apparatus 200, it may be desirable to align the weight of the jet system 210 along the roll axis 204 of the water sport apparatus 200, or to at least balance this weight about the roll axis 204. In some embodiments, the drive system 230, impeller 222, and outlet 250 are each aligned closely with the roll axis 204 of the board 110. In some embodiments, the roll axis 204 is collinear with the longitudinal centreline 118 of the board 110.

By positioning the inlet conduits 240, 260 and the inlet apertures 241, 261 on opposite sides of the roll axis 204, the weight of one conduit can counterbalance the weight of the other conduit. This can provide a net zero (or close) roll moment about the roll axis 204, meaning that the roll stability of the water sport apparatus 200 is not adversely affected by the positioning of the inlet conduits 240, 260.

In some embodiments, the inlet conduits 240 and 260 and the inlet apertures 241, 261 are positioned on opposite sides of the mast mount 116. As previously described in relation to the foil board 100, the mast mount 116 is aligned with the roll axis 204 to provide stability. The inlet conduits 240, 260 and the inlet apertures 241, 261 are thus positioned on opposite sides of the roll axis 204, with the mast mount 116 positioned between the inlet conduits 240, 260 and the inlet apertures 241, 261.

The jet system 210 may be provided as part of a kit, which can be assembled to obtain the water sport apparatus 200. The kit for the water sport apparatus 200 may comprise the board 110. The board 110 may comprise a core made from a foam material. The shell of the board 110 may be made from layers of fibreglass or carbon fibre. The first and second inlet apertures 241, 261 are formed in the shell. The jet system body 212 is configured to fluidly connect to the first and second inlet apertures 241, 261 through the cavity 270 and recess 272 formed in the core of the board 110.

The cavity 270 is configured to at least partially receive the jet system body 212. When the jet system body 212 is received by the cavity 270, the first and second inlet conduits 240, 260 are configured to be in fluid communication with the first and second inlet apertures 241, 261 respectively. The kit may also comprise the shroud to cover the jet system body 212 when in the cavity 270. The shroud may also be made from layers of fibreglass or carbon fibre.

The board 110 may be approximately 1 m to 2 m in length. In some embodiments, the board may be approximately 1.2 m to 1.6 m (4 ft to 5 ft) in length. The board 110 may be approximately 0.3 m to 0.8 m wide. The board 110 may be approximately 0.3 m to 0.6 m wide. In some embodiments, the board may be approximately 0.45 m to 0.5 m (18 in to 20 in) wide. In some embodiments, the board 110 may be about 69 cm wide.

The kit for the water sport apparatus 200 may further comprise the mast mount 116, the mast 120, the foil 130, the propulsion system 220 and/or the controller 234. The cavity 270 may be sized to receive the propulsion system 220. The cavity 370 may be sized to receive the drive system 330. The cavity 370 may also receive the mast mount 116 (for attaching the mast 120 and the foil 130). The shroud may also cover these components when they are received in the cavity 270.

By way of example, the position of the drive system 230 in the board 110 is shown as a dash-dot line in FIG. 2. In some embodiments, the drive system 230 is positioned above the mast mount 116. In other words, the drive system 230 may be positioned between the first end 112 and the mast mount 116. As previously described, the mast mount 116 comprises at least one rail or track. The mast mount 116 occupies a small portion on the underside of the board 110, allowing room in the board 110 to receive the drive system 230 above the mast mount 116 and between the inlet apertures 341, 361. In some embodiments, the mast mount 116 comprises two parallel tracks which are spaced apart. Spacing apart the two parallel tracks of the mast mount 116 may create more space in the board 110 to receive the drive system 230. In this configuration, at least part of the drive system 230 may be positioned between the two parallel tracks of the mast mount 116.

The water sport apparatus 200 comprises a power supply 232. The drive system 230 comprises the power supply 232, the motor 236 and the shaft 340. The drive system 230 may further comprise a gearbox 238 connected to the motor 236 (e.g. the shaft 340). The power supply 232 is connected to the motor 236. The power supply 232 is also connected to the controller 234 to power the controller 234. The power supply 232 may be a rechargeable battery, such as a lithium-ion battery.

The controller 234 comprises one or more processor(s) 235. The controller 234 comprises memory 237. The one or more processor(s) 235 are connected to memory 237. The one or more processor(s) 235 are configured to execute instructions 239 stored in memory 237 to cause the controller 234 to function as described herein.

The controller 234 comprises a network interface 251. The network interface 251 enables the controller 234 to communicate with a computing device 253 over a communications network 255. The network interface 251 may comprise a combination of network interface hardware and network interface software suitable for establishing, maintaining and facilitating communication over a relevant communication channel. Examples of a suitable communications network 255 include a cloud server network, wired or wireless internet connection, Bluetooth™ or other near field radio communication, and/or physical media such as USB.

The one or more processor(s) 235 are configured to execute the instructions 239 stored in memory 237 to cause the controller 234 to function according to the described methods. In some embodiments, the instructions 239 are in the form of instruction program code. The one or more processor(s) 235 may comprise one or more microprocessors, central processing units (CPUs), application specific instruction set processors (ASIPs), application specific integrated circuits (ASICs) or other processors capable of reading and executing instruction code.

Memory 237 may comprise one or more volatile or non-volatile memory types. For example, memory 237 may comprise one or more of random access memory (RAM), read-only memory (ROM), electrically erasable programmable read-only memory (EEPROM) or flash memory. Memory 237 is configured to store program code accessible by the one or more processor(s) 235. The program code comprises executable program code modules. In other words, memory 237 is configured to store executable code modules configured to be executed by the one or more processor(s) 235. The executable code modules, when executed by the one or more processor(s) 235 cause the controller 234 to perform certain functionality, as described in more detail herein.

The controller 234 comprises a user interface 229. One or more user(s) can submit requests to the controller 234 using the user interface 229. The controller 234 can provide outputs to the user using the user interface 229. In other words, the user interface 229 is configured to enable the user to provide an input to and/or provide an output from the controller 234. The user interface 229 may comprise one or more user interface components, such as one or more of a display device, a touch screen display, a keyboard, a mouse, a camera, a microphone, buttons, switches and lights. In particular, the user interface 229 may comprise a propulsion system activation button. Upon activation of the propulsion system activation button, the controller 234 may activate the propulsion system 220, as described herein. The propulsion system activation button may be a physical button. Alternatively, the propulsion system activation button may be a virtual button displayed on a touch screen of the user interface 229.

In some embodiments, the user interface 229 is positioned towards the front end 112 of the board 110. The user interface 229 is positioned closer to the front end 112 of the board 110 than the rear end 114. The board 110 comprises a user interface recess 227. The user interface 229 is configured to be received by the user interface recess 227, and retained within the user interface recess 227 during use of the water sport apparatus 200. A seal is formed between a perimeter of the user interface 229 and a corresponding perimeter of the user interface recess 227 to inhibit water ingress into the user interface recess 227 during use.

In some embodiments, the board 110 comprises a user interface lumen 225 that extends between the user interface recess 227 and the cavity 270. One or more components of the controller 234 (e.g. the one or more processor(s) 235) may be contained in the cavity 270. Electrical wires configured to enable communication between the user interface 229 and the one or more processor(s) 235 of the controller 234 may extend through the user interface lumen. Alternatively, in some embodiments, the user interface 229 is configured to wirelessly communicate with the one or more processor(s) 235 of the controller 234.

In some embodiments, the user interface 229 comprises a handheld remote. The remote may be configured to wirelessly communicate with the one or more processor(s) 235. The user interface 229 may comprise a display on the handheld remote that functions as described previously, and/or may communicate with a display on the board 110.

The controller 234 comprises a sensor system 271. The sensor system 271 is connected to the one or more processor(s) 235. The controller 234 is configured to process sensor data obtained using the sensor system 271. In particular, the one or more processor(s) 235 are configured to process the sensor data. In some embodiments, the controller 234 is configured to store the sensor data in memory 237. The sensor system 271 comprises a sensor 273. A sensor characteristic of the sensor 273 changes in response to a change in a sensor input. The sensor input may be associated with an environment of the sensor 273. The environment of the sensor 273 may comprise a volume that is in the proximity of the sensor 273. Therefore, the sensor characteristic of the sensor 273 may change in response to a change in the environment of the sensor 273. Such a sensor characteristic may be referred to as an environmental characteristic. The sensor input may be associated with a state of the sensor 273. The state of the sensor 273 may comprise one or more of a pose, a velocity, a speed and an acceleration of the sensor 273. Therefore, the sensor characteristic of the sensor 273 may change in response to a change in the state of the sensor 273. Such a sensor characteristic may be referred to as a state characteristic.

The one or more processor(s) 235 are configured to be in communication with the sensor 273 to determine a value of the sensor characteristic at a particular time. In other words, the one or more processor(s) 235 are configured to be in communication with the sensor 273 to measure the sensor characteristic. For example, the one or more processor(s) 235 may be electrically connected to the sensor 273. The one or more processor(s) 235 may measure the sensor characteristic at a measurement frequency. The measurement frequency may be referred to as a sampling frequency. The sensor data may therefore comprise a time series of measurements of the sensor characteristic made at the measurement frequency. In some embodiments, the sensor characteristic corresponds to an environmental characteristic of the environment of the sensor 273. In some embodiments, the sensor characteristic corresponds to a state characteristic of the sensor 273. The one or more processor(s) 235 may use the measured sensor characteristic as an input of a transfer function to determine the environmental characteristic and/or the state characteristic. The output of the transfer function when the measured sensor characteristic is used as the input of the transfer function may be the environmental characteristic and/or the state characteristic.

For example, in some embodiments the sensor 273 comprises a thermistor. In these embodiments, the one or more processor(s) 235 are configured to measure a potential difference across the thermistor. Thus, in these embodiments, the sensor characteristic is the potential difference across the thermistor. As the potential difference across the thermistor is related to a temperature of the thermistor and/or a temperature of the environment of the thermistor, the corresponding environmental characteristic may be the temperature of the thermistor and/or the temperature of the environment of the thermistor. In this case, the sensor data described herein may be said to comprise temperature data.

In some embodiments, the sensor system 271 comprises a plurality of sensors 273. The sensor characteristic of two or more of the plurality of sensors 273 may be sensitive to a different environmental characteristic. The sensor characteristic of two or more of the plurality of sensors 273 may be sensitive to a different state characteristic.

In the illustrated embodiment, the sensor system 271 comprises a gyroscope 273A. The one or more processor(s) 235 are configured to determine gyroscopic data using the gyroscope 273A. The gyroscopic data is associated with the water sport apparatus 200. In particular, the gyroscopic data is indicative of an orientation of the water sport apparatus 200. In other words, the orientation of the water sport apparatus 200 may be the state characteristic of the gyroscope 273A. The sensor data described herein may therefore comprise the gyroscopic data.

The sensor system 271 comprises a magnetometer sensor 273B. The one or more processor(s) 235 are configured to determine magnetic field data using the magnetometer sensor 273B. The magnetic field data is associated with the water sport apparatus 200. In particular, the magnetic field data is indicative of an azimuth orientation of the water sport apparatus 200. In other words, the azimuth orientation of the water sport apparatus 200 may be the state characteristic of the magnetometer sensor 273B. The sensor data described herein may therefore comprise the magnetic field data.

The sensor system 271 comprises an accelerometer 273C. The one or more processor(s) 235 are configured to determine acceleration data using the accelerometer 273C. The acceleration data is associated with the water sport apparatus 200. In particular, the acceleration data is indicative of an acceleration of the water sport apparatus 200. The accelerometer data is indicative of acceleration in one or more of a first acceleration direction, a second acceleration direction and a third acceleration direction. The first acceleration direction, second acceleration direction and third acceleration direction may be orthogonal with respect to each other. Thus, the acceleration of the water sport apparatus 200 may be the state characteristic of the accelerometer 273C. The sensor data described herein may therefore comprise the acceleration data.

The sensor system 271 comprises a GNSS module 273D. The one or more processor(s) 235 are configured to determine GNSS data using the GNSS module 273D. The GNSS data is indicative of one or more of a latitude, a longitude and an altitude of the water sport apparatus 200. The GNSS data may be in the form of a GNSS data vector that is indicative of the latitude, longitude and/or altitude of the water sport apparatus 200 at a particular point in time. Alternatively, the GNSS data may comprise GNSS time-series data. The GNSS time-series data can be indicative of the latitude, longitude and/or altitude of the water sport apparatus 200 over a time window. The GNSS time-series data can include GNSS data vectors that are sampled at a particular GNSS time frequency. The GNSS data may include a GNSS uncertainty metric that is indicative of an uncertainty of the relevant GNSS data. Sampling the GNSS data vectors at a particular GNSS time frequency provides a measurement of the change of position of the apparatus 200 over time. This may be used to determine the speed of the apparatus 200. The rate of change of the speed may be used to determine the acceleration of the apparatus 200. The GNSS data (which measures speed and acceleration) may be combined with the acceleration data (for example, measured by accelerometer 273C). The velocity/acceleration of the apparatus 200 as measured by the accelerometer 273C and the velocity/acceleration of the apparatus 200 as measured by the GNSS module 273D can be compared to each other to determine an accurate velocity/acceleration measurement.

The GNSS module 273D may be configured to utilise a plurality of GNSS constellations. For example, the GNSS module 273D may be configured to utilise one or more of a Global Positioning System (GPS), a Global Navigation Satellite System (GLONASS), a BeiDou Navigation Satellite System (BDS), a Galileo system, a Quasi-Zenith Satellite System (QZSS) and an Indian Regional Navigation Satellite System (IRNSS or NavIC). In some embodiments, the GNSS module 273D is configured to utilise a plurality of GNSS frequencies simultaneously. In some embodiments, the GNSS module 273D is configured to utilise a plurality of GNSS constellations simultaneously.

The one or more processor(s) 235 are configured to receive the GNSS data from the GNSS module 273D. The sensor data described herein may therefore comprise the GNSS data. In some embodiments, the sensor system 271 comprises an ultrasonic sensor module. The ultrasonic sensor module may measure the speed of the apparatus 200 and transmit this information to the one or more processor(s) 235. The ultrasonic sensor module may comprise at least one ultrasonic transducer mounted on the bottom of the board. The at least one ultrasonic transducer may be mounted at least substantially flush with the bottom of the board to reduce drag. In some embodiments, the ultrasonic sensor module comprises a pair of ultrasonic transducers. The pair of ultrasonic transducers are spaced apart at a set difference, and the time taken for the particles in the water to travel between the transducers is measured. The speed of the water can therefore be determined, either by the one or more processor(s) 235 or by a controller of the ultrasonic sensor module. Examples of ultrasonic sensor modules used in marine applications include modules manufactured by Airmar and NKE. In some embodiments, the ultrasonic sensor module's speed measurements are combined with speed measurements obtained from the GNSS module 273D and/or the accelerometer 273C.

The sensor system 271 comprises a thermistor 273E. The one or more processor(s) 235 are configured to determine temperature data using the thermistor 273E. The temperature data is associated with the water sport apparatus 200. In particular, the temperature data is indicative of a temperature of a portion of the water sport apparatus 200. In other words, the temperature of the portion of the water sport apparatus 200 may be the environmental characteristic of the thermistor 273E. In some embodiments, the thermistor 273E may be positioned at, or adjacent to the motor 236. In some embodiments, the thermistor 273E may be positioned at, or adjacent to the one or more processor(s) 235. In some embodiments, the sensor system 271 may comprise a plurality of thermistors 273E. The sensor system 271 may comprise a first thermistor and a second thermistor. The first thermistor may be positioned at, or adjacent to the motor 236. The second thermistor may be positioned at, or adjacent to the one or more processor(s) 235. The sensor data described herein may therefore comprise the temperature data.

The one or more processor(s) 235 are configured to determine a value of one or more operational parameter(s). The one or more processor(s) 235 are configured to determine a value of one or more operational parameter(s) using the sensor data. The one or more processor(s) 235 are configured to determine a value of one or more operational parameter(s) using other data (e.g. other operational data).

The one or more operational parameter(s) comprise a thrust estimate parameter. The value of the thrust estimate parameter is indicative of a thrust of the propulsion system 220. In particular, the value of the thrust estimate parameter is indicative of the thrust provided by the propulsion system 220 at a particular time.

In some embodiments, the one or more operational parameter(s) comprise a current parameter. In particular, the thrust estimate parameter may comprise the current parameter. A value of the current parameter is indicative of a current drawn by the motor 236. In particular, the value of the current parameter is indicative of the current drawn by the motor 236 at a particular time. As the current drawn by the motor 236 is proportional to the thrust provided by the propulsion system 220, the thrust can be inferred from the value of the current parameter. The one or more processor(s) 235 may be configured to determine a value of the current parameter.

In some embodiments, the one or more operational parameter(s) comprise a revolutions-per-minute (RPM) parameter. In particular, the thrust estimate parameter may comprise the RPM parameter. A value of the RPM parameter is indicative of a number of revolutions through which the rotor of the motor 236 rotates in one minute. In particular, the value of the RPM parameter is indicative of the number of revolutions through which the rotor of the motor 236 rotates in one minute, at a particular time. As the number of revolutions through which the rotor of the motor 236 rotates in one minute is proportional to the thrust provided by the propulsion system 220, the thrust can be inferred from the value of the RPM parameter. The one or more processor(s) 235 may be configured to determine a value of the RPM parameter.

The one or more operational parameter(s) comprise an acceleration estimate parameter. A value of the acceleration estimate parameter is indicative of an acceleration of the water sport apparatus 20. In particular, the value of the acceleration estimate parameter is indicative of the acceleration of the water sport apparatus 200 at a particular time. The one or more processor(s) 235 may be configured to determine the value of the acceleration estimate parameter based at least in part on the acceleration data. The value of the acceleration estimate parameter may be referred to as an acceleration estimate. The accelerometer estimate is indicative of acceleration in one or more of the first acceleration direction, the second acceleration direction and the third acceleration direction at a particular time. The value of the acceleration estimate parameter may be referred to as an acceleration estimate. In some embodiments, the acceleration estimate comprises an acceleration estimate vector.

The one or more operational parameter(s) comprise a velocity estimate parameter. A value of the velocity estimate parameter is indicative of a velocity of the water sport apparatus 200. In particular, the value of the velocity estimate parameter is indicative of velocity of the water sport apparatus 200 at a particular time. The one or more processor(s) 235 may be configured to determine the value of the velocity estimate parameter based at least in part on the GNSS data. The velocity estimate is indicative of velocity in one or more of a first velocity direction, a second velocity direction and a third velocity direction at a particular time. One or more of the first velocity direction, the second velocity direction and the third velocity direction may be orthogonal. The value of the velocity estimate parameter may be referred to as a velocity estimate. In some embodiments, the velocity estimate comprises velocity estimate vector. Determining the velocity estimate parameter at particular times using GNSS data can be used to determine the acceleration of the apparatus 200.

The one or more operational parameter(s) comprise a speed estimate parameter. A value of the speed estimate parameter is indicative of a speed of the water sport apparatus 200. In particular, the value of the speed estimate parameter is indicative of the speed of the water sport apparatus 200 at a particular time. The one or more processor(s) 235 may be configured to determine the value of the speed estimate parameter based at least in part on the GNSS data. The value of the speed estimate parameter may be referred to as a speed estimate.

The one or more operational parameter(s) comprise a temperature estimate parameter. A value of the temperature estimate parameter is indicative of a temperature of a portion of the water sport apparatus 200. In particular, the value of the temperature estimate parameter is indicative of a temperature of the portion of the water sport apparatus 200 at a particular time. The one or more processor(s) 235 may be configured to determine the value of the temperature estimate parameter based at least in part on the temperature data. In embodiments where the thermistor 273E is positioned at, or adjacent to the motor 236, the value of the temperature estimate parameter may be indicative of a temperature of the motor 236. In embodiments where the thermistor 273E is positioned at, or adjacent to the one or more processor(s) 235, the value of the temperature estimate parameter may be indicative of a temperature of the one or more processor(s) 235.

The one or more processor(s) 235 are configured to determine a value of one or more operational parameter(s) using data associated with the drive system 230. For example, the one or more processor(s) 235 are configured to determine the value of one or more operational parameter(s) using drive system data. The drive system data comprises data associated with the drive system 230. For example, the drive system data may comprise motor data. The motor data may be indicative of a value of one or more operating parameter(s) of the motor 236. For example, the motor data may comprise one or more of a potential difference, current or resistance associated with the motor 236. The motor data may comprise a back-EMF associated with operation of the motor 236 at a particular time.

The one or more operational parameter(s) comprise a total wave count parameter. A value of the total wave count parameter is indicative of a total number of waves caught by the user, using the water sport apparatus 200, during a particular usage time window. The value of the total wave count parameter may be referred to as a total wave count.

The one or more operational parameter(s) comprise a number of turns parameter. A value of the number of turns parameter is indicative of a number of turns the user completed, using the water sport apparatus 200, during a particular usage time window. The value of the number of turns parameter may be referred to as a total number of turns.

The one or more operational parameter(s) comprise a distance travelled parameter. A value of the distance travelled parameter is indicative of a distance travelled, using the water sport apparatus 200, during a particular usage time window. The value of the distance travelled parameter may be referred to as a distance travelled.

The one or more operational parameter(s) comprise a maximum turn acceleration parameter. A value of the maximum turn acceleration parameter is indicative of a maximum acceleration experienced, using the water sport apparatus 200, during a particular turn. The value of the maximum turn acceleration parameter may be referred to as a maximum turn acceleration, or a turn G-force.

The one or more operational parameter(s) comprise a pumping distance parameter. A value of the pumping distance parameter is indicative of a distance travelled while pumping the water sport apparatus 200, during a particular usage time window. The value of the pumping distance parameter may be referred to as a pumping distance.

The one or more operational parameter(s) comprise a cadence parameter. A value of the cadence parameter is indicative of a cadence when pumping the water sport apparatus 200, during a particular usage time window. The value of the cadence parameter may be referred to as a cadence or a pumping cadence.

The one or more operational parameter(s) comprise a second pumping distance parameter. A value of the second pumping distance parameter is indicative of a distance travelled between a first pump of the water sport apparatus 200 and a second pump of the water sport apparatus 200. The value of the second pumping distance parameter may be referred to as a second pumping distance.

The controller 234 is configured to transmit the sensor data to the computing device 253. The controller 234 is configured to transmit other operational data (e.g. the data associated with the drive system 230) to the computing device 235. The controller 234 is configured to transmit one or more of the determined operational parameter(s) to the computing device 235.

The controller 234 is configured to activate the drive system 230 in accordance with an activation configuration. The activation configuration comprises one or more parameters that are related to the activation of the drive system 230. These may be referred to as activation configuration parameters.

The activation configuration parameters comprise a thrust parameter. A value of the thrust parameter is indicative of a target thrust of the propulsion system 220. That is, the value of the thrust parameter may be indicative of a target thrust that it is desired for the propulsion system 220 to output when operating in accordance with the activation configuration. The value of the thrust parameter may be referred to as a thrust parameter value.

In some embodiments, the activation configuration comprises an output current parameter. A value of the output current parameter is indicative of a target current to be drawn by the motor 236. In particular, the value of the output current parameter is indicative of the target current drawn by the motor 236 at a particular time. As the current drawn by the motor 236 is proportional to the thrust provided by the propulsion system 220, the thrust can be inferred from the value of the output current parameter.

The controller 234 may control the motor 236 based at least in part on the value of the output current parameter. That is, the controller 234 may ensure the current provided to the motor 236 corresponds to the value of the output current parameter. In this way, the controller 234 may control the propulsion system 220 to output the target thrust at a target thrust time.

In some embodiments, the activation configuration comprises an output revolutions-per-minute (RPM) parameter. A value of the output RPM parameter is indicative of a target number of revolutions through which the rotor of the motor 236 is to rotate in one minute. In particular, the value of the output RPM parameter is indicative of the target number of revolutions through which the rotor of the motor 236 is to rotate in one minute, at a particular time. As the number of revolutions through which the rotor of the motor 236 rotates in one minute is proportional to the thrust provided by the propulsion system 220, the thrust can be inferred from the value of the RPM parameter.

The controller 234 may control the motor 236 based at least in part on the value of the RPM parameter. That is, the controller 234 may ensure the motor 236 operates such that the rotor of the motor 236 rotates through a number of RPMs corresponding to the value of the RPM parameter. In this way, the controller 234 may control the propulsion system 220 to output the target thrust at the target thrust time.

The target thrust time may be a time at which it is desired for the propulsion system 220 to output the target thrust when operating in accordance with the activation configuration. A value of the target thrust time may be indicative of a time between receiving an input that results in the execution of the activation configuration, and the time at which it is desired for the target thrust to be output.

The activation configuration parameters comprise an acceleration parameter. The acceleration parameter is associated with an acceleration time window over which the propulsion system 220 is activated. In particular, the acceleration parameter is associated with an acceleration time window over which the drive system 230 is activated. A value of the activation parameter is indicative of a length of the acceleration time window. The value of the activation parameter may be referred to as an activation parameter value. The activation configuration is configured such that the propulsion system 220 delivers the target thrust at the end of the acceleration time window. That is, the controller 234 may control the drive system 230 such that the thrust provided by the jet system 210 increases from a start of the acceleration time window to be equal to or near to the target thrust at the end of the acceleration time window.

The activation configuration parameters comprise thrust duration parameter. The thrust duration parameter is associated with thrust duration time window over which the propulsion system 220 is activated. In particular, the thrust duration parameter is associated with thrust duration time window over which the drive system 230 is activated. A value of the thrust duration parameter is indicative of a length of the thrust duration time window. The value of the thrust duration parameter may be referred to as a thrust duration parameter value.

The activation configuration parameters comprise a maximum speed parameter. The maximum speed parameter is associated with a maximum speed at which the water sport apparatus 200 is to be propelled. A value of the maximum speed parameter is indicative of the maximum speed at which the water sport apparatus 200 is to be propelled. The value of the maximum speed parameter may be referred to as a maximum speed parameter value. The activation configuration is configured such that the propulsion system 220 does not accelerate the water sport apparatus 200 to a speed that is greater than the value of the maximum speed parameter. In other words, the controller 234 will not accelerate the water sport apparatus 200 to a speed that is greater than the value of the maximum speed parameter.

The activation configuration parameters comprise a cavitation time parameter. The cavitation time parameter is associated with cavitation time window over which the propulsion system 220 is enabled to operate while cavitation is occurring. In other words, the cavitation time parameter is associated with a cavitation time duration during which the drive system 230 is enabled to operate while cavitation is occurring. A value of the cavitation time parameter is indicative of a length of the cavitation time window. The value of the cavitation time parameter may be referred to as a cavitation time parameter value.

In some embodiments, the value of one or more of the thrust parameter, the output current parameter, the output RPM parameter, the acceleration parameter, the thrust duration parameter, the maximum speed parameter and the cavitation time parameter is pre-set. In some embodiments, the controller 234 is configured to receive a value of one or more of the thrust parameter, the output current parameter, the output RPM parameter, the acceleration parameter, the thrust duration parameter, the maximum speed parameter and the cavitation time parameter via the user interface 229. The controller 234 may store the value of one or more of the thrust parameter, the output current parameter, the output RPM parameter, the acceleration parameter, the thrust duration parameter, the maximum speed parameter and the cavitation time parameter in memory 237.

As described herein, the controller 234 is configured to communicate with the computing device 253 using the communications network 255. The computing device 253 comprises a user interface 257 whereby one or more user(s) can submit requests to the computing device 253, and whereby the computing device 253 can provide outputs to the user. The user interface 257 may comprise one or more user interface components, such as one or more of a display device, a touch screen display, a keyboard, a mouse, a camera, a microphone, buttons, switches and lights.

The computing device 253 also comprises a computing device network interface 259. The computing device network interface 259 enables the controller 234 to communicate with the computing device 253 over the communications network 255. The computing device network interface 259 may comprise a combination of network interface hardware and network interface software suitable for establishing, maintaining and facilitating communication over a relevant communication channel.

The jet system 210 may comprise a cooling system for dissipating heat generated from operation of the jet system 210 and/or the drive system 230. The cooling system may be a passive cooling system which provides cooling by the movement of fluid. The cooling system may comprise at least one of a vent, a fan, a heatsink, or a radiator. The heat generated may be dissipated by the cooling system being in communication with the surrounding air or water. In embodiments where the cooling system comprises a heatsink or a radiator, the heatsink or radiator may be disposed within the inlet conduits 240, 260 or may be in contact with an exterior portion of the inlet conduits 240, 260. In this way, the heat can be transferred into the fluid moving through the inlet conduits 240, 260.

The kit may be supplied in a completely unassembled state or in a partly assembled state. Some embodiments of the kit may be combined or replaced with other parts. For example, the jet system 210 may be combined with the user's own board, or with the user's own foil 130.

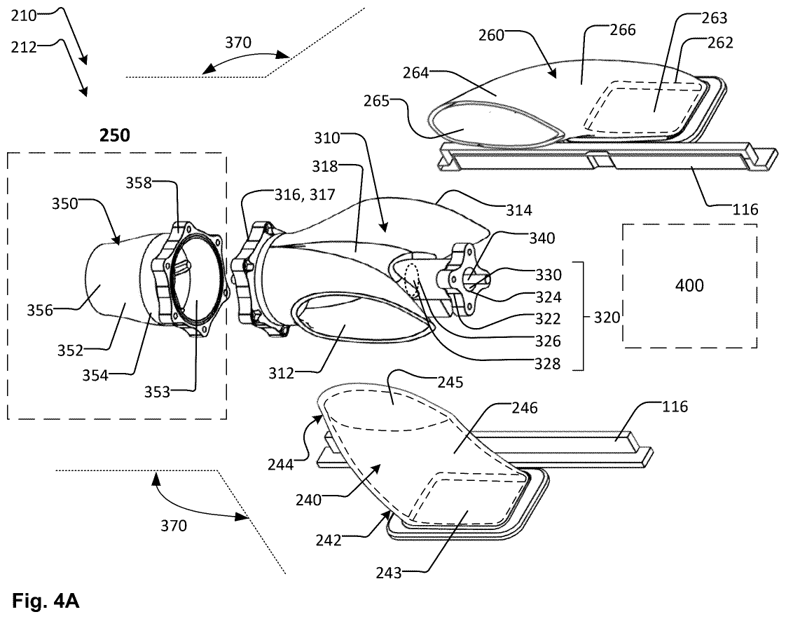

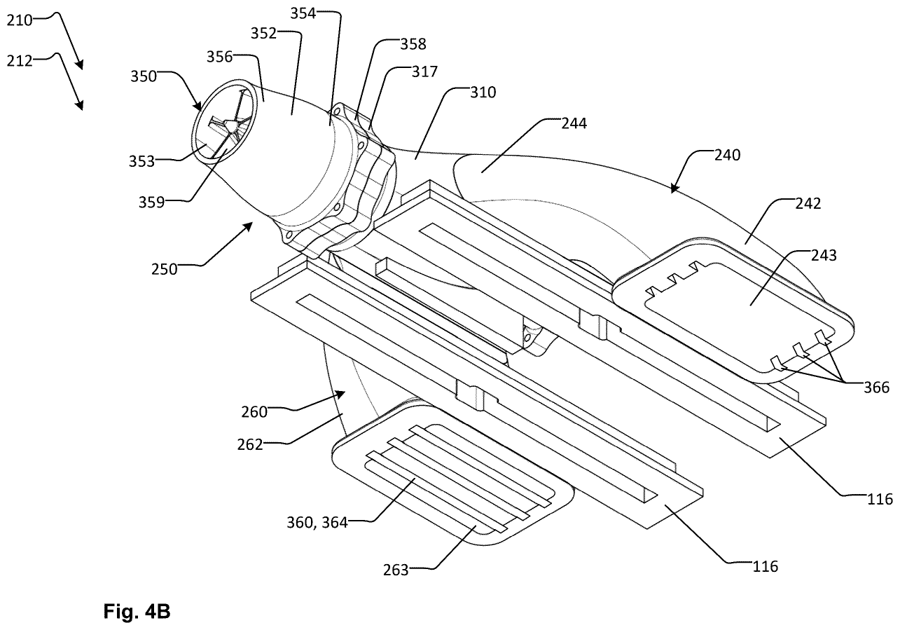

FIGS. 4A and 4B show further detail of the jet system 210 and the jet system body 212, according to some embodiments. FIG. 4A is an exploded view of the jet system 210 as seen from above. FIG. 4B is a perspective view of the jet system 210 as assembled and as seen from underneath. The mast mount 116 is shown in FIGS. 4A and 4B for reference positioning, and is not intended to suggest that the mast mount 116 is part of the jet system 210.

FIG. 4A shows parts of the first and second inlet conduits 340, 360 in phantom to allow viewing of various sub-features in the same drawing. The first inlet conduit 240 comprises a first inlet end 242 defining a first inlet opening 243, shown in phantom. The first inlet conduit 240 comprises a first outlet end 244 defining a first outlet opening 245, shown in phantom. The first inlet conduit 240 comprises a first lumen 246, shown in phantom, extending from the first inlet opening 243 to the first outlet opening 245.

The first inlet opening 243 is configured to be fluidly connected to, or in fluid communication with, the first inlet aperture 241. When fluidly connected or communicable, fluid entering the first inlet aperture 241 may then flow through the first lumen 246, passing through the first inlet end 242 towards the first outlet end 244. The fluid may then pass through the first outlet end 244 and out of the first outlet opening 245.

The second inlet conduit 260 comprises a second inlet end 262 defining a second inlet opening 263. The second inlet conduit 260 comprises a second outlet end 264 defining a second outlet opening 265. The second inlet conduit 260 comprises a second lumen 266 extending from the second inlet opening 263 to the second outlet opening 265.

The second inlet opening 263 is configured to be fluidly connected to, or in fluid communication with, the second inlet aperture 261. When fluidly connected or communicable, fluid entering the second inlet aperture 261 may then flow through the second lumen 266, passing through the second inlet end 262 towards the second outlet end 264. The fluid may then pass through the second outlet end 264 and out of the second outlet opening 265.

The first and second inlet apertures 241, 261 are disposed on either side of the mast mount 116. That is, the first and second inlet apertures 241, 261 are disposed on opposing sides of the mast mount 116.

In some embodiments, the jet system body 212 further comprises a manifold 310. The manifold 310 fluidly connects the inlet conduits 240, 260 to the outlet 250 so that fluid passes from the inlet apertures 241, 261 to the impeller 222. In other words, the manifold 310 is fluidly connected to, or in fluid communication with, the first outlet opening 243 and the second outlet opening 263. The outlet 250 is configured to receive the impeller 222, which draws fluid through the first and second inlet conduits 240, 260 through the manifold 310 and into the outlet 250.

The exploded view of FIG. 4A shows the manifold 310 and the inlet conduits 240, 260 as separate components for clarity. In some embodiments, the manifold 310 and the inlet conduits 240, 260 may be formed as a single piece. The manifold 310 and the inlet conduits 240, 260 may be moulded or cast as a single piece (or as separate pieces to be joined together) using metal casting or plastic moulding. A composite material, such as carbon fibre or fibreglass may also be layered over a mould to form the manifold 310 and the inlet conduits 240, 260 as a single piece or as separate pieces to be joined together.

The manifold 310 comprises a first manifold inlet 312. The first manifold inlet 312 is fluidly connected to, or in fluid communication with, the first inlet conduit 240. The manifold 310 comprises a second manifold inlet 314. The second manifold inlet 314 is fluidly connected to, or in fluid communication with, the second inlet conduit 260. That is, the first manifold inlet 312 is fluidly connected to, or is in fluid communication with the first lumen 246 and the second manifold inlet 314 is fluidly connected to or is in fluid communication with the second lumen 266. The manifold 310 comprises a manifold outlet 316. The manifold outlet 316 is fluidly connected to, or in fluid communication with the outlet 250 of the jet system body 212. The manifold 310 comprises a plenum 318. The plenum 318 is fluidly connected to, or in fluid communication with the first manifold inlet 312, the second manifold inlet 314, and the manifold outlet 316. The manifold inlets 312, 314 and the manifold outlet 316 may be disposed at opposite ends of the plenum 318. Fluid is configured to enter the manifold 310 via the manifold inlets 312, 314, and transit the plenum 318, before being discharged through the manifold outlet 316.

In some embodiments, the manifold 310 comprises a drive conduit 320. The drive conduit 320 comprises a drive conduit inlet end 322 defining a drive conduit inlet opening 324. The drive conduit 320 (and in particular, the drive conduit inlet opening 324) may be disposed between the first manifold inlet 312 and the second manifold inlet 314.

The drive conduit 320 comprises a drive conduit outlet end 326 defining a drive conduit outlet opening 328. The drive conduit 320 comprises a drive conduit lumen 330 extending from the drive conduit inlet opening 324 to the drive conduit outlet opening 328. At least part of the drive conduit 320 may be fluidly connected to the plenum 318.

The drive system 230 may be configured to connect to the drive conduit 320, such as at the drive conduit inlet opening 324. The drive conduit lumen 330 may be configured to receive a part of the drive shaft 340 connecting the drive system 230 to the impeller 222. The impeller 222 may be disposed adjacent to the manifold outlet 316. In some embodiments, the plenum 318 is arranged between the drive system 230 and the impeller 222. The drive shaft 340 may thus extend through the manifold 310 and/or plenum 318 to connect the drive system 230 and the impeller 222.

As previously described, the drive system 230 comprises the power supply 232, the motor 236, and/or the gearbox 238. The power supply 232, the controller 234, the motor 236, and/or the gearbox 238 are arranged along the longitudinal axis 118 so that their respective centres of mass are aligned with, or near the roll axis 204. In some embodiments, at least one of the power supply 232, the controller 234, the motor 236, and the gearbox 238 is disposed outside of the manifold 310. At least one of the power supply 232, the controller 234, the motor 236, or the gearbox 238 may be positioned away from the inlet apertures 241, 261. The drive shaft 340 may extend from the motor 236 through the drive conduit lumen 330 to the impeller 222.

The drive system 230 is configured to drive the impeller 222 to move fluid from at least one of the first inlet end 242 and the second inlet end 262, into the manifold 310, and into the outlet 250 of the jet system body 212 via the manifold outlet 316.

In some embodiments, the outlet 250 of the jet system body 212 comprises a nozzle 350. The nozzle 350 may comprise a nozzle body 352, a nozzle inlet end 354, and a nozzle outlet end 356. The nozzle body 352 comprises the nozzle inlet end 354 and the nozzle outlet end 356, which may be fluidly connected, or in fluid connection. The nozzle inlet end 354 and the nozzle outlet end 356 may be disposed at opposite ends of the nozzle body 352. The nozzle body 352 may be tubular and define an internal surface 353. The nozzle body 352 may have an internal diameter sized to receive the impeller 222 therein. For clarity, the impeller 222 is not shown in FIGS. 4A and 4B to allow the internal surface 353 to be more clearly seen.

The nozzle 350 may direct the ejected fluid in a particular direction. In some embodiments, the nozzle body 352 comprises flow guidance structures 359 which help to direct the flow of fluid through the nozzle 350 after it passes the impeller 222. The flow guidance structures 359 may assist with conditioning or guiding the flow of fluid as it exits the nozzle 350 at the nozzle outlet end 356. The flow guidance structures 359 may comprise at least one fin or wing. The nozzle body 352 may taper at the nozzle outlet end 356 to increase the speed of the ejected fluid.

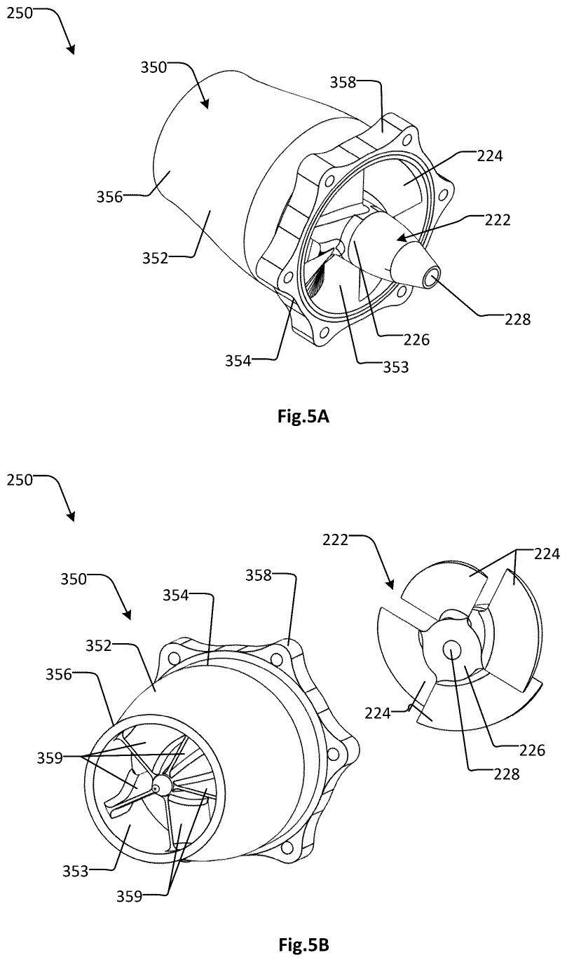

FIG. 5A is a perspective view of the impeller 222 as received in the nozzle 350. FIG. 5B is an exploded view of FIG. 5A, viewed from a reverse angle. The impeller 222 has a plurality of blades 224 which move fluid when the impeller 222 is rotated. The blades 224 are mounted to the impeller hub 226. The impeller hub 226 defines a hub lumen 228 which is configured to receive and connect to the drive shaft 340 so that the drive shaft 340 can rotate the impeller 222. To transmit torque and rotate the impeller 222, the drive shaft 340 may be a keyed shaft or a splined shaft that engaged with the hub 226 via a corresponding shaft key or spline. This allows the impeller 222 to be removed from the drive shaft 340 for ease of repair or replacement. As the impeller 222 rotates, the tips of the blades 224 define an envelope of the impeller 222. The envelope is defined by the outer diameter/sweep of the blades 224.

The inner diameter of the nozzle body 352 is larger than the outer diameter or sweep of the blades 224 of the impeller 222. At least part of the internal surface 353 of the nozzle body 352 is preferably closely fitted around the impeller 222, such as shown in FIG. 5A. A closely fitted nozzle body 352 directs more fluid through the envelope of the impeller 222, rather than outside the outer diameter of the blades 224. The reduced gap between the tips of the impeller blades 224 and the inner diameter of the nozzle body 352 thereby allows the impeller blades 224 to draw more fluid through the impeller 222 (compared to an impeller and nozzle with a larger gap therebetween).

The nozzle 350 may direct the ejected fluid in a particular direction. In some embodiments, the nozzle body 352 comprises flow guidance structures 359 which help to direct the flow of fluid through the nozzle 350 after it passes through the impeller 222. The flow guidance structures 359 may assist with conditioning or guiding the flow of fluid as it exits the nozzle 350 at the nozzle outlet end 356. The flow guidance structures 359 may comprise at least one fin or wing. The nozzle body 352 may taper at the nozzle outlet end 356 to increase the speed of the ejected fluid.

Continuing to refer to FIGS. 5A and 5B, with further reference to FIGS. 4A and 4B, the nozzle 350 may further comprise a flange 358. The flange 358 may be configured to enable the outlet 250 of the jet system body 212 to be connected to the manifold outlet 316. The manifold outlet 316 may have a matching flange 317 to allow the flange 358 to be connected thereto to form a flanged connection. The flanges 317, 358 may be connected by removable fasteners, such as bolts. The flanged connection allows the nozzle 350 to be easily removed and cleaned or replaced. For example, the internal surface 353 of the nozzle body 352 may become worn through use, particularly when the nozzle body 352 and impeller 222 are closely fitted. The wear on the internal surface 353 of the nozzle body 352 may be caused by the blades 224 of the impeller 222 eroding or abrading the internal surface 353. The nozzle 350 may also become damaged from external impact. The flanged connection of the flanges 317, 358 allows the nozzle 350 to be replaced without having to replace the impeller 222 as well.

The flange 358 may be integrally formed with the nozzle 350. The flange 358 may be connected to the nozzle 350 by welding or by removable means such as a threaded connection. For example, the flange 358 may be a substantially ring-shaped with a threaded connection on the inside of the ring, and this threaded connection is configured to mate with a corresponding threaded connection on the outside of the nozzle body 352. The flange 358 may be connected to the nozzle 350 at the nozzle inlet end 354.

Referring again to FIGS. 4A and 4B, the manifold 310 may be fluidly connected to, or in fluid communication with, the first outlet opening 245 of the first inlet conduit 240. The manifold 310 may be fluidly connected to, or in fluid communication with, the second outlet opening 265 of the second inlet conduit 260. The first inlet conduit 240 and the second inlet conduit 260 may extend and/or branch out from the manifold 310 such that the first inlet end 242 and the second inlet end 262 are spaced apart. The first inlet end 242 and the second inlet end 262 may be spaced apart and disposed on opposite sides of the longitudinal axis of the board 110 or on opposite sides of the roll axis 204. In some embodiments, the first inlet end 242 and the second inlet end 262 are spaced apart while the first outlet end 244 and the second outlet end 264 are not spaced apart, so that the outlet ends 244, 264 are fluidly connected to, or in fluid communication with, the same portion of the manifold 310.

By spacing apart the first inlet end 242 and the second inlet end 262, the jet system body 212 defines a gap 300 between the first inlet end 242 and the second inlet end 262 in which at least part of the propulsion system 220 or drive system 230 can be received. For example, the motor 236 may be disposed in the gap 300.

The length of the gap 300 can be increased by spacing apart the first inlet conduit 240 and the second inlet conduit 260 beyond their inlet ends 242, 262. For example, the first inlet conduit 240 may be spaced apart from the second inlet conduit 260 along a first length of the first inlet conduit 240. The first length extends from the first outlet end 244 to the first inlet end 242. The first length may correspond with a length of the first lumen 246.

Similarly, the second inlet conduit 260 may be spaced apart from the first inlet conduit 240 along a second length of the second inlet conduit 240. The second length extends from the second outlet end 264 to the second inlet end 262. The second length may correspond with a length of the second lumen 266.

In some embodiments, the first and second inlet conduits 240, 260 are spaced apart along their lengths so that the first inlet end 242 and the first outlet end 244 are spaced apart from the second inlet end 262 and the second outlet end 264. In this way, the outlet ends 244, 264 are fluidly connected to, or in fluid communication with, different portions of the manifold 310.

In some embodiments, the first inlet conduit 240 may extend from a first side portion of the manifold 310. The second inlet conduit 260 may extend from a second side portion of the manifold 310. The second side portion of the manifold 310 may be opposed to the first side portion of the manifold 310. The first and second side portions may, for example, be left and right side portions of the manifold 310, as divided by a notional reference plane such as a plane of symmetry.

The first body side portion of the jet system body 212 may comprise the first inlet end 242. The second body side portion of the jet system body 212 may comprise the second inlet end 262. The first body side portion may be an opposing side portion of the jet system body 212 to the second body side portion.

The jet system body 212 may be symmetrical about a plane of symmetry. The plane of symmetry is a notional reference plane and may be between the first and second inlet ends 242, 262. The propulsion system 230 may be intersected by the plane of symmetry. In some embodiments, the outlet 250 of the jet system body 212 is intersected by the plane of symmetry. The plane of symmetry may coincide with the centreline of the outlet 250 so that the first and second inlet ends 242, 362 are mirror images of each other. In other words, the outlet 250 may be bisected by the plane of symmetry. In some embodiments, the first and second inlet conduits 240, 260 are mirror images of each other about the plane of symmetry.

In some embodiments, the jet system body 212 defines a Y shape. The Y shape comprises the first and second inlet ends 242, 262 in spaced apart relation (forming the gap 300), with the outlet 250 disposed between and offset from the inlet ends 242, 262. The Y shaped jet system body 212 may be asymmetrical. In some embodiments, the Y shaped jet system body 212 is symmetrical so that the first and second inlet conduits 240, 260 are mirror images of each other. The Y shape may orient at least part of the inlet conduits 240, 260 at an obtuse angle (marked 370) to the direction of fluid flowing through the outlet 250. In some embodiments, such as shown FIGS. 4A and 4B, the outlet ends 244, 264 of the inlet conduits 240, 260 are at an obtuse angle 370 to the direction of fluid flowing through the outlet 250. In this way, the change of direction of fluid as it enters the manifold 310 is relatively gradual, compared to an acute angle configuration.

In some embodiments, the first inlet conduit 240 comprises a first arcuate portion defining an arcuate portion of the first lumen 246. In some embodiments, the second inlet conduit 260 comprises a second arcuate portion defining an arcuate portion of the second lumen 266. The first and second arcuate portions may increase the width of the gap 300 between the first and second inlet conduits 240, 260 when traversing along their length, away from the manifold 310, thereby enabling a reduction in the length of the jet system body 212.

The first inlet opening 243 may have a cross sectional area that is equal to a cross sectional area of the first outlet opening 245. Any change in shape or curvature of the inlet conduits 240, 260 and lumens 246, 266 may be gradual. In some embodiments, the first inlet opening 243 has a cross sectional area that is larger than a cross sectional area of the first outlet opening 245. A larger area at the inlet opening enables more fluid to enter the first inlet conduit 240. A smaller area at the first outlet opening 245 enables improved control of the amount and rate of fluid flowing out of the first inlet conduit 240. The cross sectional area of the first lumen 246 may accordingly reduce in size or taper along the length of the first inlet conduit 240. Alternatively, the cross sectional area of the first lumen 246 may vary along the length of the first inlet conduit 240, such as increasing in size before reducing towards the first outlet opening 245.

Similarly, the second inlet opening 263 may have a cross sectional area that is larger than a cross sectional area of the second outlet opening 265. The cross sectional area of the second lumen 266 may accordingly reduce in size or taper along the length of the second inlet conduit 260. Alternatively, the cross sectional area of the second lumen 266 may vary along the length of the second inlet conduit 260, such as increasing in size before reducing towards the second outlet opening 265.

The fluid flow through the jet system body 212 may in some embodiments be regulated by a valve or a plurality of valves. The valve may be a one-way valve to prevent or reduce reverse flow through the jet system body 212.

To further affect the characteristics of the fluid flowing through the first lumen 246 and the second lumen 266, the first inlet conduit 240 and the second inlet conduit 260 may comprise respective flow guidance structures. The flow guidance structures may assist with conditioning or guiding the flow of fluid through the first and second inlet conduits 240, 260. The first and/or second flow guidance structures may comprise one or more of: a winglet, fin, baffle, ridge, vane, and groove. The type, size, and orientation of the first and second flow guidance structures may be different or identical to each other depending on the type and amount of flow conditioning desired.

For example, at least one of the flow guidance structure(s) may be disposed on an internal wall of the first inlet conduit 240 and/or on an internal wall of the second inlet conduit 260. In this way, fluid passing through the first lumen 246 and the second lumen 266 may be guided towards the outlet 250 of the jet system body 212 with the desired speed and direction. This may also improve the performance of the impeller 222.

The performance of impeller 222 may be adversely affected by contact with debris. To reduce the likelihood of large debris entering the first and second inlet conduits 240, 260 and impacting the impeller 222, the jet system body 212 may comprise at least one grille 360 to filter such debris. In particular, the jet system body 212 may comprise a first grille 362 disposed at the first inlet end 242, and a second grille 364 disposed at the second inlet end 262.

The bars of the grille 360 (e.g. the first grille 362 and/or the second grille 364) may be received in slots 366 formed in the first and second inlet openings 243, 263 respectively. For clarity, FIG. 4B shows the second grille 364 installed to cover the second inlet opening 263, with the first grille 362 removed to show the slots 366. The grilles 362, 364 may be secured in their respective slots 366 by a clamp arrangement, by adhesive, or by removable fasteners.

The first grille 362 and the second grille 364 may be removably connected to the respective inlet ends 242, 262 to allow easy access into the first lumen 246 and the second lumen 266 for maintenance. Alternatively, the first grille 362 and the second grille 364 may be integrally formed with the respective inlet ends 242, 262 to reduce the likelihood of the grilles 362, 364 inadvertently not being attached after maintenance.

The inlet ends 242, 262 may be rectangular shaped or circular shaped. The size of the inlet ends 242, 262 may be adjusted to control the amount of fluid ingested into the manifold 310 and subsequently directed through the impeller 222. The inlet apertures 241, 261 formed in the underside of the board 110 are shaped to correspond with the shape of the inlet ends 242, 262.

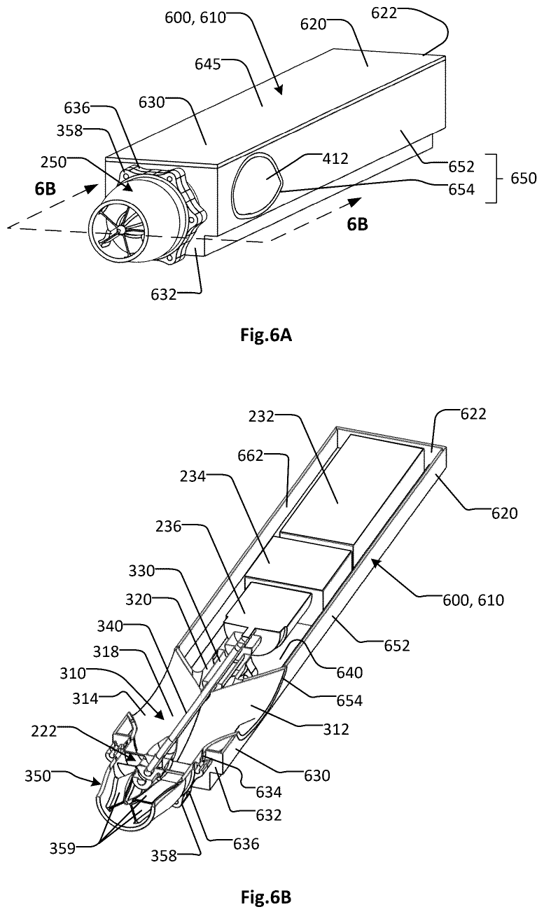

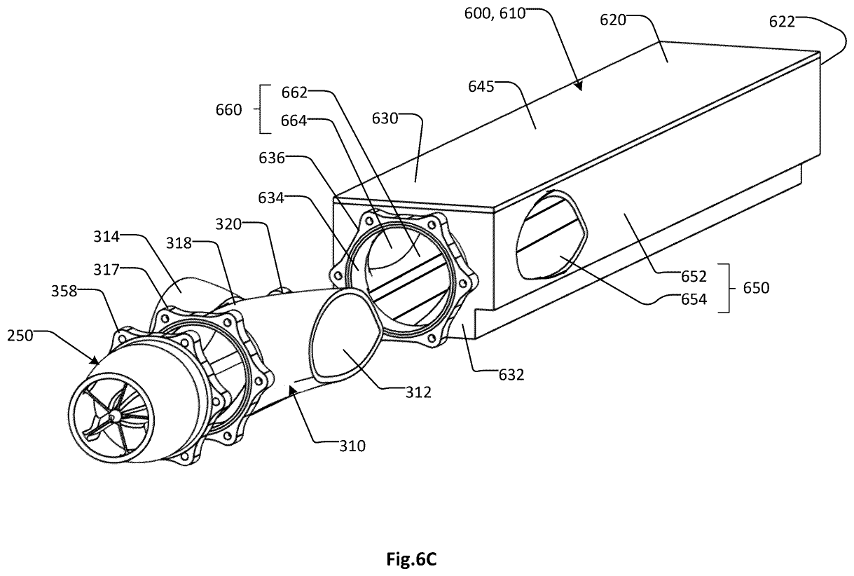

Turning now to FIGS. 6A, 6B and 6C, some embodiments of the jet system 210 comprise a cartridge 600. FIG. 6B is a section view of FIG. 6A, as taken along the line 6B-6B. FIG. 6C is an exploded view of FIG. 6A.

The cartridge 600 comprises a cartridge body 610 having a head end 620 and an oppositely disposed tail end 630. The tail end 630 of the cartridge 600 is configured to be connected to the outlet 250.

The cartridge body 610 comprises a plurality of cartridge body walls which define a cartridge cavity 640. As shown in FIG. 6B, the cartridge cavity 640 is configured to contain at least part of the manifold 310. The manifold 310 may be integrally formed with the cartridge body 610. The cartridge cavity 640 is configured to contain at least part of the drive system 230. In some embodiments, one or more of the power supply 232, the controller 234, and the motor 236 are contained within the cartridge cavity 640. The cartridge body 610 may comprise a panel or lid 645 which is removable to allow access to the cavity 640.

The cartridge body 610 comprises a first cartridge body wall 622 disposed at the head end 620, and a second cartridge body wall 632 disposed at the tail end 630. The outlet 250 is configured to be attached to the second cartridge body wall 632. The manifold plenum 318 and the nozzle 350 are disposed on opposite faces of the second cartridge body wall 632. The second cartridge body wall 632 defines a cartridge body wall aperture 634 which fluidly connects or communicates the manifold 310 to the outlet 250. In some embodiments, the manifold outlet 316 extends through the cartridge body wall aperture 634. The cartridge body 610 may comprise a cartridge body flange 636 which surrounds the cartridge body wall aperture 634. The flange 317 of the manifold outlet 316 may connect to the cartridge body flange 636 so as to be connected with the flange 358 of the nozzle 350. The second cartridge body wall 632 may define a plurality of flange holes to allow bolts or other fasteners to pass therethrough for connecting the flanges 636, 317, 358.

The cartridge body 610 further comprises a first cartridge body side portion 650 and a second cartridge body side portion 660. The first and second cartridge body side portions 650, 660 connect the head end 620 and the tail end 630. The first and second cartridge body side portions 650, 660 may be oppositely disposed. The first cartridge body side portion 650 comprises a first cartridge body side wall 652. The second cartridge body side portion 660 comprises a second cartridge body side wall 662. As shown in FIG. 6C, the first cartridge body side wall 652 defines a first cartridge conduit aperture 654. The second cartridge body side wall 662 comprises a second cartridge conduit aperture 664.

In some embodiments of the jet system 210, such as shown in FIG. 6B, the manifold 310 is contained within the cartridge cavity 640. The manifold inlets 312, 314 may abut the cartridge conduit apertures 654, 664. The manifold inlets 312, 314 may be approximately the same size as the cartridge conduit apertures 654, 664.

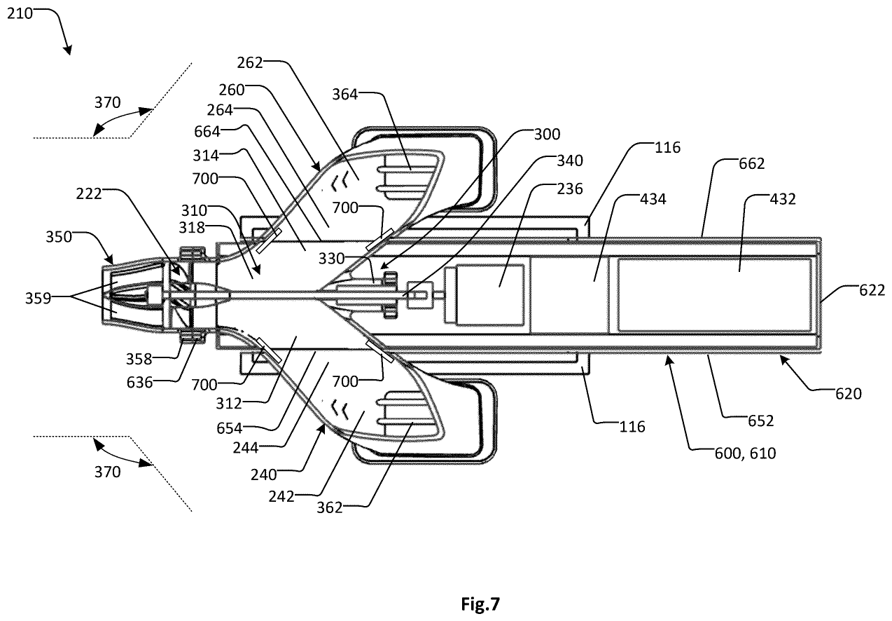

In some embodiments, the first and second inlet conduits 240, 260 (not shown in FIGS. 6A-6C for clarity; refer FIG. 7) are separate pieces to the manifold 310 and are configured to fluidly connect to or communicate with the manifold 310 through the first and second cartridge conduit apertures 654, 664 respectively. Specifically, the first outlet end 244 of the first inlet conduit 240 is configured to fluidly connect to or communicate with the first manifold inlet 312 through the first cartridge conduit aperture 654. Similarly, the second outlet end 264 of the second inlet conduit 260 is configured to fluidly connect to or communicate with the second manifold inlet 314 through the second cartridge conduit aperture 664.

FIG. 7 is the section view as shown in FIG. 6B, as viewed from above and now showing the first and second inlet conduits 240, 260 as attached to the cartridge 600. To minimise fluid leakage as it flows from the inlet conduits 240, 260 into the manifold 310, in some embodiments the outlet ends 244, 264 of the inlet conduits 240, 260 may each include an extension portion 700. The extension portion 700 may be configured to pass through the cartridge conduit apertures 654, 664 and enter the manifold inlets 312, 314 to guide fluid from the inlet conduits 240, 260 into the manifold 310. The extension portion 700 may form a lip around the perimeter of the first and second outlet openings 245, 265 which protrudes to bridge any gap with the cartridge conduit apertures 654, 664. This may reduce or prevent fluid seepage through the cartridge conduit apertures 654, 664.

FIG. 7 shows the compact packaging provided by the twin-intake arrangement of the jet system 210. The first and second inlet conduits 240, 260 are adjacent to the mast mount 116, which provides a shorter configuration than if the inlet conduits 240, 260 were to be placed forward of the mast mount 116 instead. A shorter, longitudinally compact configuration may provide weight and/or balance advantages as previously discussed herein.

The first inlet conduit 240 and the second inlet conduit 260 are arranged to extend from the manifold 310. The first inlet conduit 240 and the second inlet conduit 260 are spaced apart from each other. The inlet conduits 240, 260 are spaced apart along an axis that is substantially perpendicular to a thrust direction. The thrust direction is the direction in which fluid is ejected from the jet system 210 through the nozzle 350.

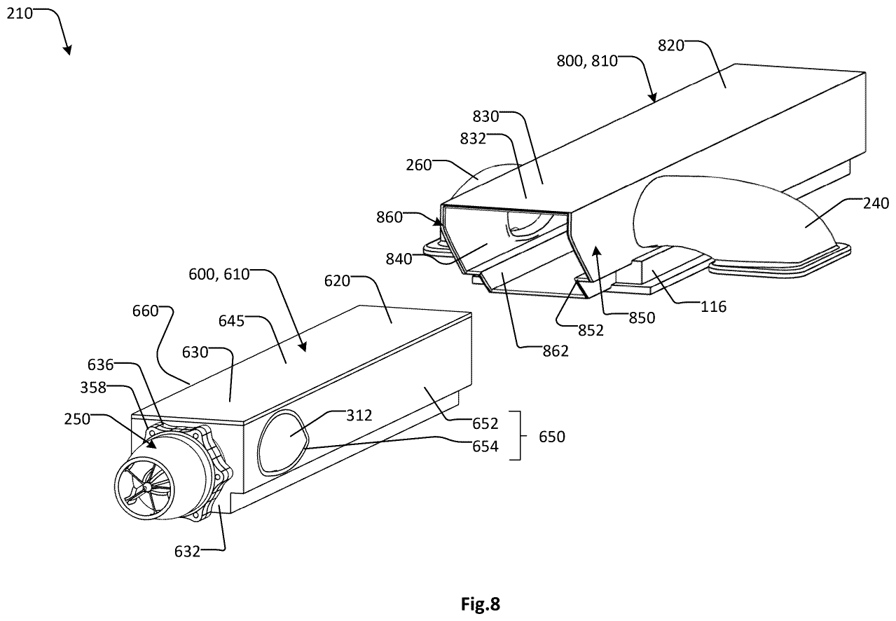

FIG. 8 shows an embodiment of the jet system 210 comprising a cartridge housing 800. The cartridge housing 800 may be embedded within the board 110 to provide a rigid surface with which the cartridge 600 can engage and be locked in place.

The cartridge housing 800 comprises a body 810 having a head end 820 and an oppositely disposed tail end 830. The body 810 comprises a plurality of walls defining a cavity 840 configured to receive the cartridge 600. The cartridge 600 and the cartridge housing 800 may be elongate. Installation of the cartridge 600 into the cartridge housing 800 may involve sliding the head end 620 of the cartridge 600 into the cartridge housing 800 until the cartridge head end 620 engages with the cartridge housing head end 820. The cartridge tail end 630 may then engage with the cartridge housing tail end 830. The inlet conduits 240, 260 may then be positioned over the cartridge conduit apertures 654, 664 so as to be in fluid communication with the manifold 310 (via manifold inlets 312, 314 as previously described).

In some embodiments, the cartridge housing tail end 830 comprises a hood 832 configured to extend over the outlet 250. When the cartridge 600 is properly received in the cartridge housing 800, the outlet 250 may be partly covered by the hood 832. The hood 832 may protect the outlet 250, particularly the nozzle 350, from damage.

The cartridge housing 800 may comprise side portions 850, 860 configured to engage with the first and second cartridge body side portions 650, 660. The side portions 850, 860 facilitate the installation and removal of the cartridge 600 by providing a guide which appropriately positions the cartridge 600 when slid into the cartridge housing 800. The side portions 850, 860 may respectively comprise a step or rail 852, 862 which restricts lateral and vertical movement of the cartridge 600 when slid into the cartridge housing 800. The cartridge housing cavity 840 may also be sized to fit snugly around the outer surfaces of the cartridge 600, thereby also limiting the amount of movement of the cartridge 600 when inside the cartridge housing 800.

The cartridge 600 (whether alone or in combination with the cartridge housing 800) provides a modular arrangement which allows the jet system 210 to be removed from the board 110. This allows the board 110 to potentially be used without the jet system 210. This also allows the jet system 210 to be utilised over multiple boards. The modular arrangement allows the jet system 210 to be easily removed from the board 110, for example for maintenance.

### Computer-Implemented Method 1000 for Controlling the Water Sport Apparatus 200

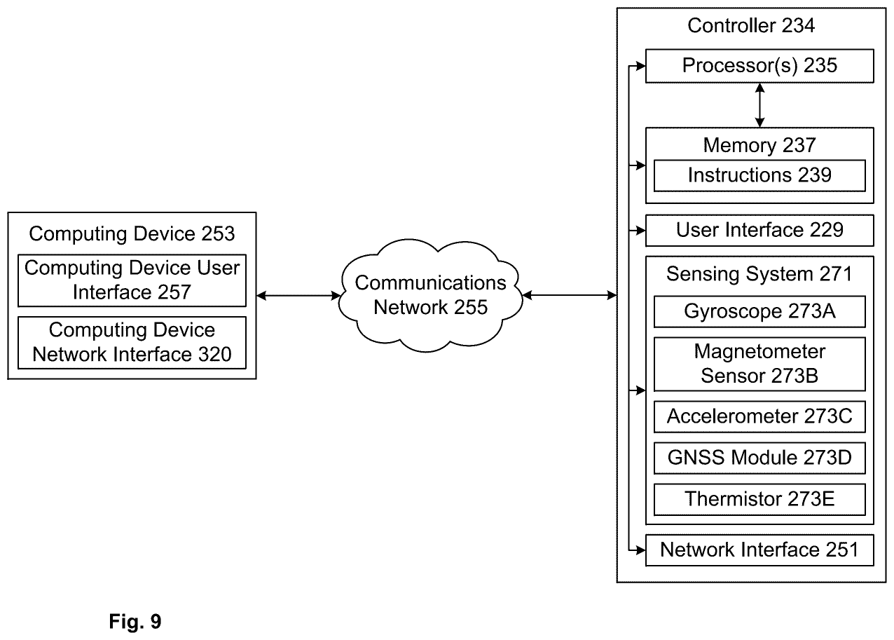

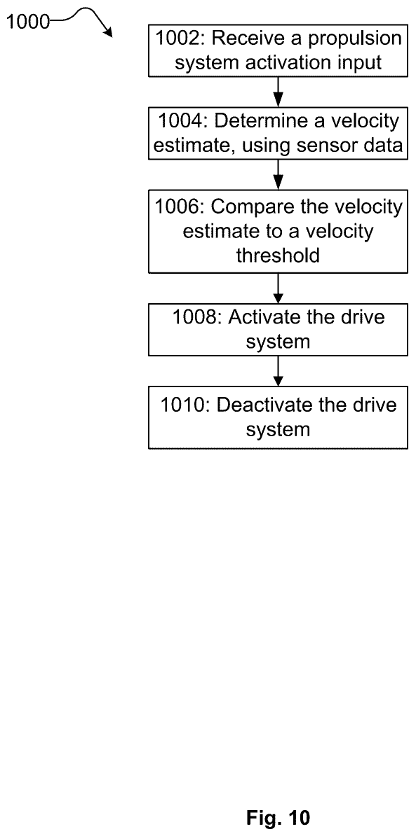

Referring now to FIG. 10, there is shown a process flow diagram of a computer-implemented method 1000 for controlling the water sport apparatus 200. In some embodiments, the computer-implemented method 1000 is performed by the controller 234 (illustrated in FIG. 9). For example, the one or more processor(s) 235 may be configured to execute the instructions 239 stored in memory 237 to cause the controller 234 to perform some or all of the computer-implemented method 1000.

At 1002, the controller 234 receives a propulsion system activation input. The controller 234 receives the propulsion system activation input via the user interface 229. For example, the controller 234 may detect the user pressing the propulsion system activation button. The controller 234 (e.g. the one or more processor(s) 235) may detect the user pressing the propulsion system activation button by detecting a change in a characteristic (e.g. resistance, voltage or current) associated with the propulsion system activation button.

At 1004, the controller 234 determines a speed estimate. The speed estimate is indicative of a speed of the water sport apparatus 200. In particular, the speed estimate is indicative of a speed of the water sport apparatus 200 at a speed estimate time. The speed estimate time is a time that is associated with the speed estimate. The controller 234 determines the speed estimate using the sensor data.

In some embodiments, determining the speed estimate comprises determining a velocity estimate vector. The velocity estimate vector is indicative of the velocity of the water sport apparatus 200. The velocity estimate vector may comprise a plurality of velocity estimate vector elements. The velocity estimate vector may comprise a respective velocity estimate vector element for each of the first velocity direction, the second velocity direction and the third velocity direction. The value of each of these velocity estimate vector elements may correspond to a speed of the water sport apparatus 200 in the respective direction. The velocity estimate vector may comprise a velocity estimate vector element associated with the speed estimate time.

In some embodiments, determining the speed estimate comprises determining a magnitude of the velocity of the water sport apparatus 200. Thus, the speed estimate may comprise the magnitude of the velocity estimate vector.

In some embodiments, the controller 234 determines a first position estimate that is indicative of a first position of the water sport apparatus 200 at a first time. As described herein, the controller 234 is configured to determine GNSS data using the GNSS module 273D. In particular, the one or more processor(s) 235 are configured to determine GNSS data using the GNSS module 273D. The GNSS data may be in the form of a GNSS data vector that is indicative of the latitude, longitude and/or altitude of the water sport apparatus 200 at a particular point in time.

The controller 234 determines the first position estimate using first GNSS data that is associated with the first time. The first GNSS data may be indicative of the latitude, longitude and/or altitude of the water sport apparatus 200 at the first time.

The controller 234 determines a second position estimate that is indicative of a second position of the water sport apparatus 200 at a second time. The controller 234 determines the second position estimate using second GNSS data that is associated with the second time. The second GNSS data may be indicative of the latitude, longitude and/or altitude of the water sport apparatus 200 at the second time.

The controller 234 determines the speed estimate based at least in part on a difference between the first position estimate and the second position estimate and a difference between the first time and the second time. In particular, the controller 234 determines a distance between the first position estimate and the second position estimate. This may be a distance in 2D or 3D space. The controller 234 determines the difference between the first time and the second time. The controller 234 may then determine the speed estimate by dividing the determined distance between the first position estimate and the second position estimate by the determined difference between the first time and the second time.

At 1006, the controller 234 compares the speed estimate to a speed threshold. The speed threshold may be stored in memory 237. The speed threshold is associated with a minimum speed at which the propulsion system 220 is to be activated. A value of the speed threshold is indicative of the minimum speed at which the propulsion system 220 is to be activated. That is, the controller 234 will not activate the propulsion system 220 if the determined speed estimate is below the speed threshold.

At 1008, the controller 234 activates the propulsion system 220. The controller 234 activates the propulsion system 220 in accordance with the activation configuration. In particular, the controller 234 activates the drive system 230. The controller 234 activates the drive system 230 to drive the impeller 222. The controller 234 activates the drive system 230 in response to the speed estimate being equal to or greater than the speed threshold, and receiving the propulsion system activation input. The controller 234 activates the drive system 230 if both of these conditions are met. In some embodiments, the controller 234 activates the drive system 230 if both of these conditions are met within an allowable time window.

If the controller 234 receives the propulsion system activation input but the speed estimate is less than the speed threshold, the controller 234 does not activate the drive system 230. If the speed estimate is equal to or greater than the speed threshold, but the controller 234 has not received the propulsion system activation input, the controller 234 does not activate the drive system 230.

It should be noted that in some embodiments, the controller 234 may activate the drive system 230 automatically, when one or more conditions are met. For example, in some embodiments, the controller 234 may activate the drive system 230 in response to the speed estimate being equal to or greater than the speed threshold. The controller 234 may do this regardless of whether or not the propulsion system activation input has been received.

Avoiding activating the propulsion system 220 when the water sport apparatus 200 is travelling below the speed threshold can advantageously improve the utilisation of the power supply 232. A significant amount of power can be required from the power supply 232 if the water sport apparatus 200 is travelling below the speed threshold, to enable the propulsion system 220 to propel the water sport apparatus 200 to travel at or above the speed threshold. Requiring the user to bring the water sport apparatus 200 to the speed threshold prior to activating the propulsion system 220 can therefore provide a relatively large increase in the operating capability of the water sport apparatus 200 (e.g. the life of the power supply 232, where it is a battery), without a significant decrease in the user's experience.

At 1010, the controller 234 deactivates the drive system 230. In particular, the controller 234 deactivates the drive system 230 in response to the thrust estimate parameter satisfying a thrust criterion. As described herein, the controller 235 is configured to determine a value of one or more operational parameter(s) during use of the water sport apparatus 200. The controller 235 may determine the value of the one or more operational parameter(s) at a plurality of sequential times during use. That is, the controller 235 may determine time series data comprising values of one or more of the one or more operational parameter(s) over a time period of use of the water sport apparatus 200.

The one or more operational parameter(s) comprise a thrust estimate parameter that is indicative of a thrust of the propulsion system 220. In some embodiments, the thrust estimate parameter comprises a current parameter. As described herein, the value of the current parameter is indicative of the current drawn by the motor 236 at a particular time. In some embodiments, the controller 234 deactivates the drive system 230 in response to the current parameter satisfying a current criterion.

The current criterion may require the value of the current parameter to be above a current threshold at a first time, and below the current threshold at a second time that is after the first time.

For example, the controller 234 may determine a value of the current parameter at a first time. The value of the current parameter at the first time is indicative of the thrust provided by the propulsion system 220 at the first time. The controller 234 may determine the value of the current parameter at the first time using the sensor data. The controller 234 may determine the value of the current parameter at the first time using the operational data. For example, the controller 234 may determine the value of the current parameter at the first time using the motor data.

The controller 234 may determine a value of the current parameter at a second time. The value of the current parameter at the second time is indicative of the thrust provided by the propulsion system 220 at the second time. The second time may be referred to as a second thrust determination time. The second time is after the first time. The controller may determine the value of the current parameter at the second time using the sensor data. The controller may determine the value of the current parameter at the second time using the operational data. For example, the controller 234 may determine the value of the current parameter at the second time using the motor data.

The controller 234 may compare the value of the current parameter at the first time to a current threshold. The current threshold may be stored in memory 237. When the propulsion system 220 is activated to propel the water sport apparatus 200 through the water as described herein, the impeller 222 is rotated to drive water through the jet system body 212, from the first inlet opening 243 and the second inlet opening 263, through the outlet 250, to provide thrust. When the first inlet opening 243 and the second inlet opening 263 are not in contact with water (e.g. when the board 110 is suspended above the water by the lift force), the current required to rotate the impeller 222 decreases (relative to when they are in contact with water) as rotation of the impeller 222 drives air, rather than water, through the jet system body 212. The current threshold is set such that it is associated with the decrease in current that occurs when one or both of the first inlet opening 243 and the second inlet opening 263 come out of contact with water. That is, a current estimate being greater than the current threshold indicates that one or both of the first inlet opening 243 and the second inlet opening 263 are in contact with water, thereby propelling water through the jet system body 212 to provide thrust. A current estimate being equal to or less than the current estimate indicates that the first inlet opening 243 and the second inlet opening 263 are not in contact with water (e.g. when the board 110 is suspended above the water by the lift force).

The controller 234 may compare the value of the current parameter at the second time to the current threshold. The value of the current parameter at the first time being greater than the current threshold indicates that at or near the first time, one or both of the first inlet opening 243 and the second inlet opening 263 were in contact with water. The value of the current parameter at the second time being equal to or less than the current threshold indicates that at or near the second time, the first inlet opening 243 and the second inlet opening 263 were not in contact with water, and therefore, that the board 110 is suspended above the water. Thus, the value of the current parameter transitioning from being greater than the current threshold (when the propulsion system 220 is propelling water through the jet system body 210) to equal to or less than the current threshold (when one or both of the first inlet opening 243 and the second inlet opening 263 are not in contact with water) is indicative of the board 110 having been lifted above the water by the lift force.

In response to this determination, the controller 234 deactivates the drive system 230. In particular, the controller 234 deactivates the drive system 230 when the value of the current parameter at the first time is above the current threshold and the value of the current parameter at the second time is below the current threshold. The controller 234 may deactivate the drive system 234 by deactivating the motor 236.

As described herein, in some embodiments, the thrust estimate parameter comprises a RPM parameter. The value of the RPM parameter is indicative of a number of revolutions at which the rotor of the motor 236 rotates in one minute, at a particular time. In some embodiments, the controller 234 deactivates the drive system 230 in response to the RPM parameter satisfying a RPM criterion.

The RPM criterion may require the value of the RPM parameter to be below a RPM threshold at a first time, and above the RPM threshold at a second time that is after the first time.

For example, the controller 234 may determine a value of the RPM parameter at a first time. The value of the RPM parameter at the first time is indicative of the thrust provided by the propulsion system 220 at the first time. The controller 234 may determine the value of the RPM parameter at the first time using the sensor data. The controller 234 may determine the value of the RPM parameter at the first time using the operational data. For example, the controller 234 may determine the value of the RPM parameter at the first time using the motor data.

The controller 234 may determine a value of the RPM parameter at a second time. The value of the RPM parameter at the second time is indicative of the thrust provided by the propulsion system 220 at the second time. The second time may be referred to as a second thrust determination time. The second time is after the first time. The controller 235 may determine the value of the RPM parameter at the second time using the sensor data. The controller may determine the value of the RPM parameter at the second time using the operational data. For example, the controller 234 may determine the value of the RPM parameter at the second time using the motor data.

The controller 234 may compare the value of the RPM parameter at the first time to a RPM threshold. The RPM threshold may be stored in memory 237. When the propulsion system 220 is activated to propel the water sport apparatus 200 through the water as described herein, the impeller 222 is rotated to drive water through the jet system body 212, from the first inlet opening 243 and the second inlet opening 263, through the outlet 250, to provide thrust. When the first inlet opening 243 and the second inlet opening 263 are not in contact with water (e.g. when the board 110 is suspended above the water by the lift force), the RPM at which the motor 236 rotates the impeller 222 increases (relative to when they are in contact with water) as rotation of the impeller 222 drives air, rather than water, through the jet system body 212. The RPM threshold is set such that it is associated with the increase in RPM that occurs when one or both of the first inlet opening 243 and the second inlet opening 263 come out of contact with water. That is, the value of the RPM parameter being less than the RPM threshold indicates that one or both of the first inlet opening 243 and the second inlet opening 263 are in contact with water, thereby propelling water through the jet system body 212 to provide thrust. The value of the RPM parameter being equal to or greater than the RPM estimate indicates that the first inlet opening 243 and the second inlet opening 263 are not in contact with water (e.g. when the board 110 is suspended above the water by the lift force).

The controller 234 may compare the value of the RPM parameter at the second time to the RPM threshold. The value of the RPM parameter at the first time being less than the RPM threshold indicates that at or near the first time, one or both of the first inlet opening 243 and the second inlet opening 263 were in contact with water. The value of the RPM parameter at the second time being equal to or greater than the RPM threshold indicates that at or near the second time, the first inlet opening 243 and the second inlet opening 263 were not in contact with water, and therefore, that the board 110 is suspended above the water. Thus, the value of the RPM parameter transitioning from being less than the RPM threshold (when the propulsion system 220 is propelling water through the jet system body 210) to equal to or greater than the RPM threshold (when one or both of the first inlet opening 243 and the second inlet opening 263 are not in contact with water) is indicative of the board 110 having been lifted above the water by the lift force.

In response to this determination, the controller 234 deactivates the drive system 230. In particular, the controller 234 deactivates the drive system 230 when the value of the RPM parameter at the first time is below the RPM threshold and the value of the RPM parameter at the second time is above the current threshold. The controller 234 may deactivate the drive system 234 by deactivating the motor 236.

By operating as described, the controller 234 advantageously controls the propulsion system 220 to propel the water sport apparatus 200 from a relatively low speed to a relatively higher speed such that the lift force increases to be large enough to suspend the board 110 above the water. Once the speed of the water sport apparatus 200 is sufficient to suspend the board 110 above the water, the propulsion system 220 is disengaged, and the user can ride the board (e.g. on a wave) without further depletion of the power supply 232.

### Alternative Computer-Implemented Method 1000

In some embodiments, the controller 234 may determine that the speed of the water sport apparatus 200 is increasing (e.g. the user is paddling the board across the water) prior to activating the drive system 230. For example, the controller 234 (which may comprise sensor system 271) may determine that the speed of the water sport apparatus 200 is increasing by the acceleration measurements of at least one of the accelerometer 273C and the GNSS module 273D (part of sensor system 271). The acceleration (and rate of change of acceleration) can be used to estimate the type of wave that the user is trying to catch, for example by measuring the speed of the board as imparted to the board by the speed of the wave. At 1004, the controller 234 may therefore determine a first speed estimate. The first speed estimate is indicative of a speed of the water sport apparatus 200 at a first speed estimate time. In other words, the first speed estimate is associated with the first speed estimate time. The first speed estimate may be determined as described with reference to the speed estimate of 1004.

At 1004, the controller 234 may also determine a second speed estimate. The second speed estimate is indicative of a speed of the water sport apparatus 200 at a second speed estimate time. In other words, the second speed estimate is associated with the second speed estimate time. The second speed estimate time is after the first speed estimate time. The second speed estimate may be determined as described with reference to the speed estimate of 1004.

At 1006, the controller 234 may compare the first speed estimate to the speed threshold. At 1006, the controller 234 may also compare the second speed estimate to the speed threshold. The controller 234 may also compare the first speed estimate to the second speed estimate, and calculate a difference between the first speed estimate and the second speed estimate. A large change in the speed estimate per unit of time represents a large acceleration. A large acceleration (or large increase in acceleration) may indicate that the user is about to catch and ride on a more powerful wave, as the greater height, speed, and/or pitch of the wave quickly accelerates the board towards the maximum speed set by the maximum speed parameter. A small change in the speed estimate per unit of time represents a slow acceleration. A slow acceleration (or slow increase in acceleration) may indicate that the user is about to catch and ride on a less powerful wave, as the lower height, speed, and/or pitch of the wave gradually accelerates the board towards the maximum speed set by the maximum speed parameter. To avoid accelerating past the maximum speed set by the maximum speed parameter, the controller 234 may be configured to deactivate the drive system 230. For a large acceleration, a decrease in thrust or deactivation of the drive system 230 occurs sooner compared to a slower or more gradual acceleration, in order to avoid exceeding the maximum speed.

At 1008, the controller 234 may activate the drive system 230 to drive the impeller 222 if the speed of the water sport apparatus 200 has increased between the first speed estimate time and the second speed estimate time. In other words, the controller 234 may activate the drive system 230 in response to the first speed estimate being less than the speed threshold, and the second speed estimate being greater than or equal to the speed threshold. The activation of the drive system 230 (such as in response to the acceleration generated by the user paddling the board to match/approach the wave) increases the speed of the board and may help the user to catch the wave that they have been paddling for.

In some embodiments, the controller 234 may activate the drive system 230 to drive the impeller 222 if the speed of the water sport apparatus 200 has increased between the first speed estimate time and the second speed estimate time, without requiring receipt of the propulsion system activation input. That is, the controller 234 may automatically activate the drive system 230 in response to the speed of the water sport apparatus 200 increasing above the speed threshold from a speed that was below the speed threshold.

In some embodiments, the controller 234 requires first speed estimate time and the second speed estimate time to be within an allowable time window, for the controller 234 to activate the drive system 230. That is, the controller 234 may determine that the first speed estimate time and the second speed estimate time are within the allowable time window prior to activating the drive system 230.

### Computer-Implemented Method 1100 for Controlling the Water Sport Apparatus 200

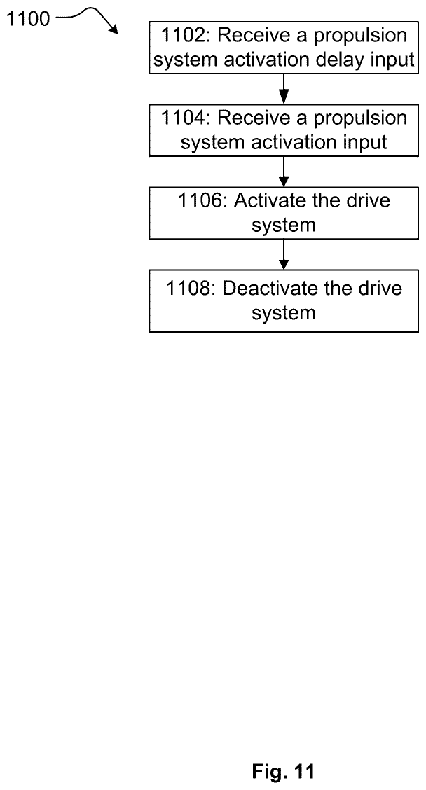

Referring now to FIG. 11, there is shown a process flow diagram of a computer-implemented method 1100 for controlling the water sport apparatus 200. In some embodiments, the computer-implemented method 1100 is performed by the controller 234 (illustrated in FIG. 9). For example, the one or more processor(s) 235 may be configured to execute the instructions 239 stored in memory 237 to cause the controller 234 to perform some or all of the computer-implemented method 1100.

At 1102, the controller 234 receives a propulsion system activation delay input. The propulsion system activation delay input is indicative of a time delay duration. The time delay duration is associated with activation of the propulsion system 220. That is, the propulsion system activation delay input is indicative of an intended time delay between the time at which the user provides the propulsion system activation input and the time at which the controller 234 is to activate the propulsion system 220. The controller 234 may receive the propulsion system activation delay input via the user interface 229. The controller 234 may store the propulsion system activation delay input in memory 237.

The controller 234 may receive a plurality of propulsion system activation delay inputs. For example, the controller 234 may receive a first propulsion system activation delay input and a second propulsion system activation delay input. Each of the propulsion system activation delay inputs may be indicative of a different intended time delay between the time at which the user provides the propulsion system activation input and the time at which the controller 234 is to activate the propulsion system 220. For example, the first propulsion system activation delay input may correspond to a 5 second delay and the second propulsion system activation delay input may correspond to a 10 second delay. The controller 234 may store each of the plurality of propulsion system activation delay inputs in memory 237.

At 1104, the controller 234 receives a propulsion system activation input. The controller 234 receives the propulsion system activation input via the user interface 229. For example, the controller 234 may detect the user pressing the propulsion system activation button. The controller 234 (e.g. the one or more processor(s) 235) may detect the user pressing the propulsion system activation button by detecting a change in a characteristic (e.g. resistance, voltage or current) associated with the propulsion system activation button. This change in characteristic of the propulsion system activation button may be the propulsion system activation input.

Alternatively, the controller 234 may receive the propulsion system activation input via a touch screen display of the user interface 229. The touch screen display of the user interface 229 may display a plurality of propulsion system activation inputs. For example, the user interface 229 may display a first propulsion system activation input and a second propulsion system activation input in the form of virtual buttons. Each of the virtual buttons may be associated with a respective propulsion system activation delay input. For example, a first virtual button may be associated with a first time delay duration (e.g. 10 seconds) and a second virtual button may be associated with a second time delay duration (e.g. 20 seconds). The user may select one of the virtual buttons on the touch screen to provide the propulsion system activation input to the controller 234. The time delay duration associated with the respective virtual button may be the one that is performed by the controller 234 in response to receiving the propulsion system activation input. In this case, the propulsion system activation input may comprise the propulsion system activation delay input.

At 1106, the controller 234 activates the propulsion system 220. The controller 234 activates the propulsion system 220 in accordance with the activation configuration. The controller 234 activates the propulsion system 220 in accordance with the propulsion system activation delay input. In particular, the controller 234 activates the drive system 230. The controller 234 activates the drive system 230 to drive the impeller 222. The controller 234 activates the drive system 230 after a time period corresponding to the time delay duration elapses. In other words, the controller 234 activates the drive system 230 to drive the impeller 222 in response to receiving the propulsion system activation input, after the time period corresponding to the time delay duration elapses.

At 1108, the controller 234 deactivates the drive system 230. In some embodiments, the controller 234 deactivates the drive system 120 in response to the thrust parameter satisfying a thrust criterion, as described at 1010. In some embodiments, the controller 234 deactivates the drive system 120 in response to the current parameter satisfying a current criterion, as described at 1010. In some embodiments, the controller 234 deactivates the drive system 120 in response to the RPM parameter satisfying the RPM criterion, as described at 1010.

By operating as described, the controller 234 advantageously controls the propulsion system 220 to propel the water sport apparatus 200 according to a pre-determined activation configuration, with minimal interaction required by the user. Once the user provides the propulsion system activation input, the controller 234 delays activating the propulsion system for the intended time delay associated with the propulsion system activation delay input. This enables the user to increase the speed of the water sport apparatus 200 (e.g. by paddling), prior to activation of the propulsion system 220, reducing depletion of the power supply 232 when compared to cases where the propulsion system 220 was used to propel the water sport apparatus 200 from a the time at which the user provided the propulsion system activation input.

### Computer-Implemented Method 1200 for Controlling the Water Sport Apparatus 200

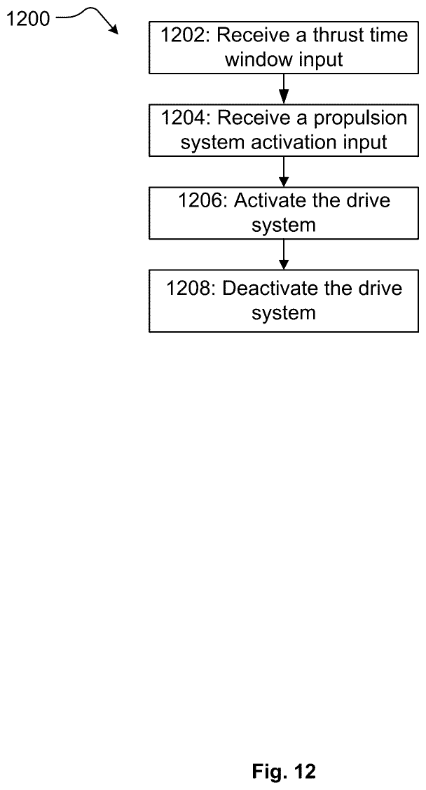

Referring now to FIG. 12, there is shown a process flow diagram of a computer-implemented method 1200 for controlling the water sport apparatus 200. In some embodiments, the computer-implemented method 1200 is performed by the controller 234 (illustrated in FIG. 9). For example, the one or more processor(s) 235 may be configured to execute the instructions 239 stored in memory 237 to cause the controller 234 to perform some or all of the computer-implemented method 1200.

At 1202, the controller 234 receives a thrust time window input. The thrust time window input is indicative of a length of a time window associated with activation of the propulsion system 220. In particular, the thrust time window input is indicative of an intended time duration for which the controller 234 is to activate the propulsion system 220 in response to receiving a propulsion system activation input. A value of the thrust time window input may correspond to an intended time duration for which the controller 234 is to activate the propulsion system 220. The controller 234 may receive the thrust time window input via the user interface 229. The controller 234 may store the thrust time window input in memory 237.

In some embodiments, the controller 234 receives a plurality of thrust time window inputs. For example, the controller 234 may receive a first thrust time window input and a second thrust time window input. Each of the thrust time window inputs may be indicative of a different intended time duration for which the controller 234 is to activate the propulsion system 220 in response to receiving a propulsion system activation input. The controller 234 may store each of the plurality of thrust time window inputs in memory 237.

At 1204, the controller 234 receives the propulsion system activation input. The controller 234 receives the propulsion system activation input via the user interface 229. For example, the controller 234 may detect the user pressing the propulsion system activation button. The controller 234 (e.g. the one or more processor(s) 235) may detect the user pressing the propulsion system activation button by detecting a change in a characteristic (e.g. resistance, voltage or current) associated with the propulsion system activation button. This change in characteristic of the propulsion system activation button may be the propulsion system activation input.

Alternatively, the controller 234 may receive the propulsion system activation input via a touch screen display of the user interface 229. The touch screen display of the user interface 229 may display a plurality of propulsion system activation inputs. For example, the user interface 229 may display a first propulsion system activation input and a second propulsion system activation input in the form of virtual buttons. Each of the virtual buttons may be associated with a respective thrust time window input. For example, a first virtual button may be associated with a first thrust time window (e.g. 10 seconds) and a second virtual button may be associated with a second thrust time window (e.g. 20 seconds). The user may select one of the virtual buttons on the touch screen to provide the propulsion system activation input to the controller 234. The thrust time window associated with the respective virtual button may be the one that is performed by the controller 234. In this case, the propulsion system activation input may comprise the thrust time window input.

At 1206, the controller 234 activates the propulsion system 220. The controller 234 activates the propulsion system 220 in accordance with the activation configuration. The controller 234 activates the propulsion system 220 in accordance with the thrust time window input. In particular, the controller 234 activates the drive system 230. The controller 234 activates the drive system 230 to drive the impeller 222. The controller 234 activates the drive system 230 for an activation duration that is equal to the duration of the relevant thrust time window. In other words, the controller 234 activates the drive system 230 to drive the impeller 222 in response to receiving the propulsion system activation input, for the thrust time window.

At 1208, the controller 234 deactivates the drive system 230. In particular, the controller 234 deactivates the drive system 230 after the activation duration elapses. In other words, the controller 234 deactivates the drive system 230 after a period of time corresponding to the thrust time window elapses. The controller 234 may deactivate the drive system 234 by deactivating the motor 236.

By operating as described, the controller 234 advantageously controls the propulsion system 220 to propel the water sport apparatus 200 according to a pre-determined activation configuration, with minimal interaction required by the user. Once the propulsion system 220 has been activated for the activation duration, the propulsion system 220 is disengaged, and the user can ride the board (e.g. on a wave) without further depletion of the power supply 232.

### Computing Device 253 Functionality

As described herein, the computing device 253 is configured to communicate with the controller 234 using the communications network 255. In some embodiments, the controller 234 is configured to transmit one or more of the determined operational parameters to the computing device 253. That is, the controller 234 is configured to transmit the value of one or more of the thrust estimate parameter, the acceleration estimate parameter, the velocity estimate parameter, the speed estimate parameter, the total wave count parameter, the number of turns parameter, the distance travelled parameter, the maximum turn acceleration parameter, the pumping distance parameter, the cadence parameter, the second pumping distance parameter and/or another parameter, to the computing device 253.

The computing device 253 is configured to provide an output to the user indicative of the value of one or more of the operational parameters, using the computing device user interface 257. For example, the computing device 253 is configured to provide an output indicative of the value of one or more of the thrust estimate parameter, the acceleration estimate parameter, the velocity estimate parameter, the speed estimate parameter, the total wave count parameter, the number of turns parameter, the distance travelled parameter, the maximum turn acceleration parameter, the pumping distance parameter, the cadence parameter, the second pumping distance parameter and/or another parameter, using the computing device user interface 257.

In some embodiments, the controller 234 is configured to transmit the sensor data to the computing device 253. The controller 234 may also be configured to transmit other data (e.g. other operational data, drive system data, motor data etc.) to the computing device 253. The computing device 253 is configured to determine output data, using one or more of the sensor data, the other operational data, the drive system data and the motor data, to be displayed using the computing device user interface 257. For example, the computing device 253 may determine a value of one or more of the thrust estimate parameter, the acceleration estimate parameter, the velocity estimate parameter, the speed estimate parameter, the total wave count parameter, the number of turns parameter, the distance travelled parameter, the maximum turn acceleration parameter, the pumping distance parameter, the cadence parameter, the second pumping distance parameter and/or another parameter, using one or more of the sensor data, the other operational data, the drive system data and the motor data, for display using the computing device user interface 257.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. (canceled)

2. (canceled)

3. (canceled)

4. (canceled)

5. A water sport apparatus comprising:
a propulsion system that is configured to propel the water sport apparatus, the propulsion system comprising:
an impeller; and
a drive system that is configured to drive the impeller to propel the water sport apparatus; and
a controller for controlling the propulsion system, the controller being configured to:
receive a thrust time window input that is indicative of a duration of a thrust time window;
activate the drive system to drive the impeller for an activation duration that is equal to the duration of the thrust time window; and
deactivate the drive system after the activation duration elapses.

6. The water sport apparatus of claim 5, wherein:
the controller is configured to:
receive a propulsion system activation input; and
activate the drive system to drive the impeller, in response to receiving the propulsion system activation input, for the activation duration.

7. The water sport apparatus of claim 5, wherein:
the controller comprises a sensor system; and
the controller is configured to process sensor data determined using the sensor system.

8. The water sport apparatus of claim 5, wherein the drive system comprises:
a motor comprising:
a stator;
a rotor; and
a shaft connected to the rotor;
wherein the shaft is configured to connect to the impeller.

9. The water sport apparatus of claim 7, wherein the sensor system comprises one or more of:
a Global Navigation Satellite System (GNSS) module that is configured to receive GNSS data;
a gyroscope;
a magnetometer; and
an accelerometer.

10. The water sport apparatus of claim 5, wherein the controller further comprises a user interface that is configured to enable a user to provide an input to the controller.

11. The water sport apparatus of claim 10, wherein the user interface comprises:
a display; and
one or more buttons.

12. The water sport apparatus of claim 6, wherein the controller further comprises a user interface that is configured to enable a user to provide an input to the controller, wherein the propulsion system activation input is received via the user interface.

13. The water sport apparatus of claim 5, wherein the controller is configured to activate the drive system in accordance with an activation configuration.

14. The water sport apparatus of claim 13, wherein the activation configuration comprises one or more activation configuration parameters, the activation configuration parameters comprising:
a thrust parameter that is associated with a target thrust of the propulsion system;
an output current parameter that is associated with a target current to be drawn by a component of the drive system;
an output revolutions-per-minute (RPM) parameter that is associated with a target RPM of the component of the drive system;
an acceleration parameter that is associated with an acceleration time window over which the drive system is activated, such that the propulsion system delivers a target thrust at an end of the acceleration time window;
a thrust duration parameter that is associated with a thrust duration time window over which the drive system is to be activated;
a maximum speed parameter that is associated with a maximum speed at which the water sport apparatus is to be propelled; and
a cavitation time parameter that is associated with a cavitation time duration.

15. The water sport apparatus of claim 14, wherein a value of one or more of the thrust parameter, the output current parameter, the output RPM parameter, the acceleration parameter, the thrust duration parameter, the maximum speed parameter and the cavitation time parameter is pre-set.

16. (canceled)

17. (canceled)

18. (canceled)

19. The water sport apparatus of claim 5, wherein the controller is configured to determine:
the value of one or more operational parameter(s) that is indicative of a thrust of the propulsion system at a first time; and
the value of one or more operational parameter(s) that is indicative of the thrust of the propulsion system at a second time that is after the first time.

20. The water sport apparatus of claim 19, wherein the one or more operational parameter(s) comprise a current parameter.

21. The water sport apparatus of claim 20, wherein the controller is further configured to:
compare the value of the current parameter at a first time to a current threshold;
compare the value of the current parameter at a second time to the current threshold; and
deactivate the drive system when:
the value of the current parameter at the first time is above the current threshold; and
the value of the current parameter at the second time is equal to or below the current threshold.

22. The water sport apparatus of claim 19, wherein the one or more operational parameter(s) comprise a revolutions-per-minute (RPM) parameter.

23. The water sport apparatus of claim 22, wherein the controller is further configured to:
compare the value of the RPM parameter at a first time to a RPM threshold;
compare the value of the RPM parameter at a second time to the RPM threshold; and
deactivate the drive system when:
the value of the RPM parameter at the first time is below the RPM threshold; and
the value of the RPM parameter at the second time is equal to or above the RPM threshold.

24. (canceled)

25. (canceled)

26. (canceled)

27. (canceled)

28. The water sport apparatus of claim 5, further comprising:
a jet system body comprising:
a first inlet conduit comprising:
a first inlet end defining a first inlet opening;
a first outlet end defining a first outlet opening;
a first lumen extending from the first inlet opening to the first outlet opening;
a second inlet conduit comprising:
a second inlet end defining a second inlet opening;
a second outlet end defining a second outlet opening;
a second lumen extending from the second inlet opening to the second outlet opening;
a manifold in fluid communication with the first outlet opening and the second outlet opening; and
an outlet in fluid communication with the manifold and configured to receive an impeller for drawing fluid through the first and second inlet conduits, through the manifold and into the outlet;
wherein the first inlet conduit and the second inlet conduit extend from the manifold such that the first inlet end and the second inlet end are spaced apart.

29. The water sport apparatus of claim 5, further comprising:
a mast mount;
a mast configured to be connected to the mast mount; and
a hydrofoil configured to be connected to the mast.

30. The water sport apparatus of claim 28, further comprising:
a mast mount;
a mast configured to be connected to the mast mount; and
a hydrofoil configured to be connected to the mast,
wherein the first inlet end and the second inlet end of the jet system body are configured to be disposed on opposite sides of the mast mount.

31. (canceled)

32. (canceled)

33. A computer-implemented method for controlling a propulsion system of a water sport apparatus, the propulsion system comprising a drive system and an impeller, the computer-implemented method comprising:
receiving a thrust time window input that is indicative of a duration of a thrust time window;
receiving a propulsion system activation input;
activating the drive system to drive the impeller, in response to receiving the propulsion system activation input, for the activation duration; and
deactivating the drive system after the activation duration elapses.
